(19) United States
(12) Patent Application Publication
(10) Pub. No.: US 2026/0266708 A1
(43) Pub. Date: Sep. 10, 2026

(54) A CELL COUNTING DEVICE FOR COUNTING TARGET CELLS WITHIN A FLUID

(71) Applicant: BEYOND BLOOD DIAGNOSTICS LTD., London (GB)

(72) Inventors: Manfredi GIOVANNI SAN MARTINO D'AGLIE DI SAN GERMANO, London (GB); Jonathan STEWART DENCH, London (GB); Andrea ATTIPOE, London (GB)

(21) Appl. No.: 19/491,241

(22) PCT Filed: Jun. 7, 2024
(86) PCT No.: PCT/GB2024/051468

§ 371 Date: Dec. 8, 2025

(30) Foreign Application Priority Data
Jun. 8, 2023 (GB) 2308510.3

(51) Int. Cl. G01N 15/14; G01N 15/10; G01N 15/1404; G01N 15/1434; G01N 15/149; G01N 21/64

(52) U.S. Cl. CPC G01N 15/147; G01N 15/1404; G01N 15/1436; G01N 15/149; G01N 21/6428; G01N 21/6458; G01N 2015/1006; G01N 2015/1486

(57) ABSTRACT

A cell counting device for counting target cells within a fluid, the device comprising: a detection module comprising a light source and a photodetector, the detection module configured to receive a detection chip comprising a cell fluid channel configured to conduct a flow of a cell-containing fluid, the detection module configured to receive the detection chip such that it is held between the light source and photodetector; wherein the light source is configured to illuminate cells flowing through the cell fluid channel when the detection chip is received in the detection module; wherein the photodetector comprises a detection area comprising a plurality of detector pixels, arranged such the cell fluid channel runs over the detection area when the detection chip is received in the detection module; the cell counting device further comprising: a control unit configured to determine a selection of the detector pixels for collecting a signal, receive a signal from the selection of photodetector pixels and determine the presence of a target cell type flowing through the cell fluid channel based on the signal.

### FIELD OF THE INVENTION

The present invention relates to the field of a cell counting device for counting cells within a fluid.

### BACKGROUND

Cell enumeration and identification are essential processes in modern medical research and diagnostics. Accordingly, methods for the analysis of bodily fluids using various technologies have become a growing area of interest to the scientific community. Existing automated cell counting devices can be categorised into three main groups based on their method of detection: optical analysis, image analysis, and electrical impedance. Such devices have many applications including haematological analysis, semen analysis, and urine analysis.

In particular, a complete blood count (CBC) test, a type of haematological analysis, provides an estimated cell count for each blood cell type in a given sample. CBC tests are one of the most commonly used diagnostic tools in hospitals today to monitor the blood count of patients undergoing chemotherapy. Chemotherapy aims to destroy cancer cells, however in the process, it affects the growth and replication of normal cells, such as blood cells produced in the bone marrow. Abnormal counts of red blood cells, white blood cells, or platelets can lead to various health complications and therefore needs to be identified early on. Such information is vital to a medical professional in order to develop an informed treatment plan based on the patient's current health status.

CBC tests may additionally provide a measure of the number of each type of white blood cell present in a sample, also known as a white blood cell differential count. This information is especially important with the observed rise in antibiotic resistant bacteria caused by the overprescription of antibiotics by doctors. Consequently, when a patient develops a bacterial infection, it needs to be identified quickly.

Currently, hospitals use sophisticated machinery to employ methods of optical analysis, electrical impedance, or centrifugal separation to carry out the blood tests discussed above. Tests of this kind are carried out using large and complex equipment, often with hazardous moving parts, restricted to use in hospitals or laboratories. Further, the equipment used to carry out blood tests is inflexible and may comprise excessive equipment unnecessary for the desired test at hand. For example, a patient may only need a CBC without a differential white blood cell count, such that specific components of the equipment are redundant. This complicates the process and may result in unnecessary labour and/or power consumption when running such tests. Therefore, there is a need for a device to replace the bulky and expensive equipment, and a device that is adaptable to various fluidic tests, particularly for at-home use.

One optical detection method proposed to solve the above-mentioned problem is a flow cytometry system based on a microfluidic chip. Flow cytometry employs lasers as a light source to produce scattered and fluorescence signals from a cell in a fluid as it passes through the light path emitted by the lasers. These signals can be detected by devices such as photosensors or photomultiplier tubes. Basing this system on a microchip requires the miniaturisation of all the components. However, due to the many complex components necessary to the functionality of the device, it is limited in both size and cost. Further, the use of lasers in these optical systems often results in alignment problems since precise alignment of the laser with detectors is required. This need for precise alignment further makes it difficult to alter the device arrangement or device components without recalibration each time. In this way, the device is unsuitable for point-of-care or at home use since expertise is required to carry out the alignment process. These problems make the device inflexible and often require the patient to obtain a different pre-aligned device for a given fluidic test.

Due to the above-mentioned problems, there exists a need for a device that is cost-effective, simple in design, and does not incur the above-mentioned alignment issues, such that it does not require cumbersome recalibration for each desired test or experiment.

### SUMMARY OF INVENTION

In a first aspect of the present invention, there is provided a cell counting device for counting target cells within a fluid, the device comprising: a detection module comprising a light source and a photodetector, the detection module configured to receive a detection chip comprising a cell fluid channel configured to conduct a flow of a cell-containing fluid, the detection module configured to receive the detection chip such that it is held between the light source and photodetector; wherein the light source is configured to illuminate cells flowing through the cell fluid channel when the detection chip is received in the detection module; wherein the photodetector comprises a detection area comprising a plurality of detector pixels, arranged such the cell fluid channel runs over the detection area when the detection chip is received in the detection module; the cell counting device further comprising: a control unit configured to determine a selection of the detector pixels for collecting a signal, receive a signal from the selection of photodetector pixels and determine the presence of a target cell type flowing through the cell fluid channel based on the signal.

Preferably the light source is an elongate light source arranged to provide an elongate illumination area. Preferably the light source is an elongate light source arranged transverse to the microfluidic channel when the detection chip is received in the detection module so as to illuminate cells flowing through the cell fluid channel.

In some examples, the elongate light source is a line light source (i.e. a single continuous illuminated strip), while in other examples the elongated light source is a plurality of point light sources (i.e. a plurality of point-like source of light) arranged along a line so as to provide an elongated light source. The light source may continuously emit light. The light source is preferably configured to provide an elongate illumination area, where the elongate illumination area is preferably transverse to the cell fluid channel when the detection chip is received in the detection module. In this way, alignment of the light source, cell fluid channel(s) and detector is simplified.

One of the major obstacles to providing a modular reusable device is the difficulty in accurately aligning the light source and cell fluid channel. The alignment is difficult to achieve with the required precision without a complex mechanism and specialist equipment, presenting a problem for users of a cell counting device, such as a patient carrying out their own blood test. This alignment issue is a major impediment to providing a home cell counting device for use by a patient.. By providing an elongate illumination area, one or more channels may be inserted such that the elongate illumination area crosses the channel(s), meaning the channels do not have to be precisely positioned.

Although in the main aspect of the disclosure, the light source comprises an elongate light source (i.e. configured to provide an elongate illumination area), in an alternative aspect of the disclosure the light source may not be an elongate light source, and may be any other type of light source, and the ease of alignment may be achieved purely with using a multipixel detector. For example, the light source may be a point light source arranged to illuminate cells passing through the cell fluid channel. The following features may equally be combined with this aspect.

The photodetector converts light into electrical signals. In some examples, the photodetector comprises an image processing detector such as a complementary metal-oxide-semiconductor (CMOS), a single-photon avalanche diode (SPAD), a Multi-Pixel-Photon Counter (MPPC). The plurality of detector pixels may also be referred to as an array of pixels (or pixel array) that is preferably a two-dimensional array.

In some examples, the cell fluid channel configured to conduct a flow of a cell-containing fluid refers to a cell fluid channel configured to convey an amount of fluid (or a sample of fluid) such that it flows in one direction along the cell fluid channel. The cell fluid channel is a channel with dimensions typically ranging from tens to hundreds of micrometers, and be referred to herein as “a microfluidic channel”. However, examples where the channel may have larger dimensions (such as thousands of micrometers) or smaller are also provided.

The target cell may be a blood cell. For example, the cell counting device may be configured for counting one or more blood cell types with a blood sample. For example the cell counting device may be configured for counting one or more of: white blood cell types (monocytes, lymphocytes, neutrophils, eosinophils, basophils, and macrophages), red blood cell types (erythrocytes), and platelets The device being configured to receive a detection chip advantageously allows for the detection chip to be interchangeable, for example, if the cell fluid channel of the chip is damaged or clogged, the detection chip may be removed from the device for replacement or cleaning. In other examples, a different detection chip may be received by the device, such that the device is able to carry out a different experiment using a detection chip more suited to the said experiment. The detection chip may be a removable component. In other examples the detection chip may be an integral component of the detection module.

The detection area comprising a plurality of detector pixels in which the control unit selects the detector pixels advantageously reduces the need for alignment of the light source with a detector. This is because the broad detection area of the detector means that alignment between the light source, cell fluid channel and detector isn't required to be precise. By providing a broad area multipixel detector and an elongate light source a cell fluid channel may be inserted between, without requiring precise alignment, and the appropriate area of the multipixel to receive a required signal may be determined. This arrangement permits modularity of the device and facilitates the ability to carry out a number of different tests and experiments due to the flexibility when selecting different pixels for experiments. For example, different pixels may be determined for measurement of an absorption signal and a forward scatter signal. Similarly, different pixels may be determined for measurement of one or more signals from cells passing through multiple cell fluid channels.

Preferably, the detection module may be configured to receive a detection chip comprising a plurality of cell fluid channels, each configured to conduct a flow of a cell-containing fluid; the elongate light source may be arranged such that it runs across the plurality of cell fluid channels when the detection chip is received in the detection module, so as to illuminate cells flowing through each cell fluid channel; and the control unit may be configured to determine a respective selection of photodetector pixels for each cell fluid channel.

A plurality of cell fluid channels allows multiple tests or experiments to be carried out simultaneously thereby speeding up the rate at which the detection device is able to obtain measurements. This is particularly useful when the device is required to produce rapid results. By providing an elongate light source (or equivalently a light source configured to provide an elongate illumination area), each of the multiple channels may be illuminated by the light source, without having to precisely align each channel with a respective light source. The elongate light source running across the plurality of channels can refer to a light source arranged perpendicular to the longitudinal axis of the cell fluid channels .. Advantageously, this means the illuminated light across each channel can be consistent, for example, the light received by each channel will be of the same wavelength and intensity, resulting in detection measurements from each channel also being consistent. Additionally, this simplifies the device by omitting the need for a different light source (i.e. a point light source) for each cell fluid channel. Selecting photodetector pixels for each channel also reduces alignment requirements and omits the need for the inclusion of a specific detector for each cell fluid channel.

Preferably, the control unit may be further configured to: determine the location of the cell fluid channel when the detection chip is received in the detection module; and determine the selection of detector pixels for collecting a signal based on the determined location of the cell fluid channel.

In some examples, the device may be configured to automatically detect the location of the cell fluid channel. The selection of the detector pixels based on the location of the cell fluid channel for collecting a signal may also be automatic. Advantageously, this removes the need for human calibration of the device since the alignment process is automated, thereby speeding up the alignment process. The location of the cell fluid channel may be determined based on the signals received by the photodetector, since the position of channels will influence the distribution of intensity across the detector pixels, which may be used to automatically infer the position of the cell fluid channels.

Preferably, the control unit may be further configured to: receive an image from the photodetector and determine the location of the cell fluid channel using image processing. In particular, the photodetector may be an imaging device.

The term “image processing” may refer to using computer algorithms to determine the location of the cell fluid channel. Examples of image processing include image enhancement, image segmentation, object recognition and texture analysis. Advantageously, this automates the process of locating the cell fluid channels, speeding up the alignment process. Further, image processing improves the accuracy and precision by which the location of the cell fluid channel is determined.

In some examples, the detection module may be configured to receive a detection chip comprising a planar cell fluid channel, the planar cell fluid channel extending across the detection area in a width direction, perpendicular to the direction of flow, so as to allow multiple cells to flow through the channel adjacent to each other in the width direction; wherein the control unit may be configured to receive image data from the photodetector to determine the position of a cell as it flows under the illumination of the light source and determine the selection of detector pixels based on the determined position of the cell.

The planar cell fluid channel extending across the detection area in a width direction may refer to a wide channel spanning across a plane surface of the detection chip. Typically, a cell fluid channel is configured such that cells of the cell-containing fluid flows consecutively through channel. In contrast, in a planar cell fluid channel, the cell-containing fluid is conducted through the channel flows such that multiple cells flow through the channel adjacent to each other in the width direction perpendicular to the flow direction. As the cells move adjacent to one another other, the cells may be moving in close proximity or side by side as they pass through the cell fluid channel. In some examples, for example when using sheath flow, the cells may not be adjacent to one another in the planar channel, but instead may be hydrodynamically focused in a stream of aligned cells by the sheath fluid.

By including a planar cell fluid channel, the need to align the detector pixels with the cell fluid channel(s) is eliminated. Instead, by using image data from the photodetector to determine the position of a cell as it flows no significant alignment is required.

In some examples, the light source may comprise: a laser light source arranged to provide elongate illumination across the cell fluid channel. The control unit may be configured to determine a selection of detector pixels for collecting a forward scatter signal from cells flowing through the cell fluid channel.

The laser light source emits a coherent and monochromatic beam of light through the process of stimulated emission. The forward scatter signal from the cells is a measure of the intensity of light scattered in the forward direction as the cell passes through the cell fluid channel, primarily via diffraction of the light by the cell. The forward scattering of the light from the cell is typically dependent on the size and shape of the cell. Advantageously, by measuring the forward scatter, the control unit may be further configured to determine and identify the cell type based on their physical properties, such as size. Selecting pixels from an array of pixels reduces the need for alignment since a pixel is selected from the array so as to collect a signal from the forward scatter of light. In particular, an area of the pixel may be determined that will receive the forward scatter signal. The may be determined based on the known location of the illumination area (e.g. by the signal received at the photodetector according to the illumination area) and the known location of the cell fluid channel. The relevant detector area may also be determined based on the determined location of the cell, for example by image processing to track the path of a cell as it travels along a channel.

In some examples, the detection module may comprise: an elongate obstruction mask arranged over the detection area so as to block direct illumination from the laser light source. In some examples, the mask may correspond with the elongated light source so as to block the direct light from the light source such that the detector pixels will not be triggered from direct laser light instead of forward scatter from the cell, thereby improving the measurements received by the detector by reducing noise in the signal.

Preferably, a detection chip may comprise a cell fluid channel configured to constrict a target cell type such that the target cell is deformed in shape as it flows through a measurement region of the cell fluid channel, the measurement region of the cell fluid channel being the portion of the cell fluid channel illuminated by the light source.

Sheath flow refers to hydrodynamic focusing of cells or cell containing-fluid into a narrow stream, for example, into a single stream of consecutively flowing cells. This can be achieved by surrounding the stream containing the cells with a sheath fluid which may flow at a higher speed than the core, for example, more than three times the speed of the core. Essentially, the sheath flow functions as a laminar flow boundary so as to maintain the consecutive flow of the cells in the core.. This technique may be used in flow cytometry and typically involves injecting a sample (e.g. the target cells) into a sheath fluid in a narrow channel (e.g. a microfluidic channel or cell fluid channel). Advantageously, using sheath flow can aid in controlling the rate of flow of the fluid in the cell fluid channel, while preventing cell build-up in the channel.

More specifically, the cell fluid channel may be configured such that it provides a constricting force to a target cell type as it flows through the measurement region. Preferably the constricting force is applied, at least partially, in a direction perpendicular to the flow direction. By providing a constricting force within the measurement region, the cell is forced to change shape. This provides greater variation in a range of different optical signals so as to better differentiate different cell types.

Preferably a minimum dimension of the microfluidic cell fluid channel is less than the diameter of a target cell type when flowing unconstricted within the fluid, such that the target cell type is deformed from its unconstricted shape as it flows through the measurement portion of the cell fluid channel. In this way the constricting force may be applied by the internal walls of the cell fluid channel. In particular, the cell fluid channel may have a dimension perpendicular to the flow direction that is less than the diameter of the target cell type (when flowing unconstricted).

In other examples the cell fluid channel is configured to provide sheath flow to focus the cell-containing fluid into a region of the cell fluid channel. Preferably the cell counting device is configured to provide a sheath fluid flow through the cell fluid channel, where the sheath fluid flow surrounds the cell containing fluid within the cell fluid channel. Preferably the sheath flow is configured such that the sheath fluid provides the constricting force to a target cell type as it flows through the measurement region. Preferably the constricting force is applied, at least partially, in a direction perpendicular to the flow direction. In particular, the cell counting device is configured such that the sheath flow provides a pressure on the target cells within the cell containing fluid.

Preferably the sheath fluid has a different flow rate to the flow of the cell-containing fluid surrounded by the sheath flow. The sheath fluid may have a flow rate of greater than two times the flow rate of the cell-containing fluid, for example three times the flow rate.

Preferably the sheath fluid has different properties to the cell-containing fluid. The sheath fluid may have a different viscosity and/or hydrophobicity to the cell-containing fluid. The viscosity and/or hydrophobicity of the sheath fluid may be selected to provide a required constricting force on the target cell type in the cell containing fluid.

In some examples, sheath flow may be used to deform the cell type by controlling the speed at which the sheath fluid flows, the hydrodynamic forces which cause a pressure to act on the cell can be manipulated so as to deform the cell. A sheath fluid with a higher viscosity, may be advantageous, since a greater pressure can be applied to the cell. Therefore, in some examples the sheath fluid may be glycerol. Glycerol is well suited to providing the required squeezing pressure to deform the target cells.

In some examples, a sheath fluid with hydrophobic and/or hydrophilic properties may be used. For example, the sheath fluid may be oil which is hydrophobic such that it does not mix with water. Since this means that oil will separate from water, if the core comprises water then there will be minimized mixing between the sheath fluid and the core fluid, such that the oil is able to provide a more distinct laminar flow boundary. In this way, the hydrophobic properties and/or the viscosity of the sheath fluid may be used to manipulate the deformation of the target cell type. Therefore, in other examples the sheath fluid may comprise an oil. The hydrophobic properties of oils ensure that the cell containing fluid, which is generally water based, will be contained within the sheath flow.

Preferably the cell counting device is configured to provide a variable constricting force to target cells within the measurement region of the cell fluid channel. Preferably the cell counting device is configured to vary the constricting force by varying the properties of the sheath flow. In particular the control unit may be configured to control the properties of the sheath flow. The control unit may be configured to increase the pressure applied by the sheath flow to target cells in the cell containing fluid. In particular, the control unit may be configured to vary the flow rate of the sheath fluid to vary the constricting force applied to target cells in the cell containing fluid. The control unit may alternatively or additionally be configured to vary the continents of the sheath fluid, for example by varying the proportion of one or more constituent fluids within the sheath fluid, thereby varying the viscosity and/or hydrophobicity. In this way, the constricting force can be varied depending on a selected target cell type to be constricted in the measurement region of the cell fluid channel.

Preferably the minimum dimension is a minimum width dimension. The term “minimum width dimension” refers to the smallest distance across the narrowest part of the cell fluid channel. In particular, the width dimension may be measured in a direction across the channel, perpendicular to the flow direction. The target cell type will deform as it flows through the cell fluid channel based on its physical (e.g. mechanical and elastic) properties. When deformed, the I forces acting on the target cell cause it to slow down. Different cell types will deform by a different amount due to a difference in the mechanical and elastic properties between the cell types. By deforming the cell as it flows through the cell fluid channel, the cell's dimensions change allow the manipulation of the forward scattered light resulting in an improved accuracy in the forward scattered measurements. In some examples, the control unit may be further configured to determine the cell type based on the signal from the forward scatter. In particular, the inventors have determined that, by selecting the channel dimensions to squeeze the cell as it passes through the illumination area, a forward scatter signal may be obtained which allows for a greater range of cell types to be identified. In particular, a cell will deform differently depending on the cell contents. These differences in deformation can be identified in forward scatter signals, allowing differentiation of similar sized cells that would not normally be possible using purely forward scatter signals. This is a significant advantage, given it could allow for a greater range of cells to be identified without any off-axis optics, such as the detectors require for side scatter signals. This significantly reduces the cost and complexity of the device, facilitating the possibility of a full differential blood count in a simple desktop device.

In some examples, the light source may comprise: an LED light source arranged to provide elongate illumination across the cell fluid channel; wherein the control unit is configured to determine a selection of detector pixels for collecting an absorption or photoluminescence signal from cells, or markers attached to cells, flowing through the cell fluid channel illuminated by the LED light source. In particular, the LED light source may be configured to provide illumination in the wavelength range 300 nm-600 nm for measurement of an absorption signal, or in the wavelength range 300 nm-1500 nm for measurement of a forward scatter signal. The LED light source may be configured to provide illumination suitable for exciting a fluorescence signal from the cell, for example by providing illumination in the wavelength range 500nm-1000 nm for measurement of a fluorescence signal. Alternatively or additionally, the LED light source may be configured to excite a fluorescence signal from a marker attached to or within a cell, for example a quantum dot attached to the cell. The LED light source may comprise more than one LEDs and be configured to emit more than one wavelength or wavelength range so as to determine or distinguish one or more cell types in a cell-containing fluid. For example the light source may comprise a plurality of LEDs, each LED configured to emit light at a suitable wavelength range for determination of a different signal.

Different cell types may have different absorption properties, such that by selecting detector pixels that collect an absorption signal from the cells, the cell type may be distinguished. The control unit may be further configured to determine the cell type based on this signal. Similarly, different cell types emit a different photoluminescence signal when excited by a specific wavelength known to the skilled person to excite the cell type. The photoluminescence signal can be used to determine physical properties of the cell, such as its composition and structure, thereby enabling the control unit to determine the cell type. The photoluminescence signal may be one or more of a fluorescence signal or a phosphorescence signal.

Preferably, the LED light source may comprise: an LED light source configured to excite fluorescence from a target cell type or excite photoluminescence from a marker attached to a target cell type; wherein the detection module may comprise a bandpass filter for permitting the passage of a fluorescence or photoluminescence signal to a portion of the detection area, but preferably blocking wavelengths outside of this range.

Specifically, fluorescence is a type of photoluminescence in which the cell type emits light after being excited by a light source. In particular, autofluorescence refers to the natural emission of fluorescence from the target cell produced when the target cell is excited by photons from the LED light source configured to excite fluorescence from a target cell type. The bandpass filter only allows a specific range of wavelengths of light to pass through, blocking other wavelengths. Therefore, using a bandpass filter for permitting the passage of a fluorescence or photoluminescence signal to a portion of the detection area allows only these wavelengths to pass through the filter and blocks out all others, improving the reliably and accuracy of the measurements received by the detector.

In some examples, the detection module may comprise a plurality of light sources, each light source comprising an elongate light source arranged to provide elongate illumination across the cell fluid channel at a different position along the flow direction of the cell fluid channel; wherein the control unit is configured to determine a selection of the detector pixels for collecting a signal associated with each of the light sources. In this way, the detector module may be configured to measure a plurality of optical signals from cells in a single module. This facilitates the modular nature of the device, since the single detector module can be connected to multiple alternative upstream cell sorting chips, which may require different signals to be measured.

In some examples, the detection module may comprise: a laser light source arranged to provide elongate illumination across a first position on the cell fluid channel for providing a forward scatter signal; and an LED light source arranged to provide elongate illumination across a second position on the cell fluid channel for providing an absorption and/or photoluminescence signal; wherein the control unit is configured to determine a first selection of detector pixels for collecting a forward scatter signal from cells flowing through the cell fluid channel and a second selection of detector pixels for collecting an absorption and/or photoluminescence signal. In other examples solely LEDs or solely laser light sources may be used, or a different combination of LEDs and laser light sources. Advantageously, by including a plurality of light sources, the device is able to gather a plurality of measurements at one time. In some examples, different types of measurements may be obtained by the device, for example, by using the laser light source to provide signals on forward scatter from the cell type and the LED to provide signal for absorption/photoluminescence of the cell, making device flexible and adaptable to different experiments. These experiments may be carried out simultaneously or one after the other.

In some examples, the detection module may comprise: an electrode assembly for measuring an electrical signal imparted by cells flowing through the cell fluid channel of the detection chip when received in the detection module. Preferably, the detection module may comprise: an electrode assembly for measuring the impedance of cells flowing through the cell fluid channel of the detection chip when received in the detection module.

In this way, the device may be used to obtain measurements of electrical signals from the cell. The electrical signal may include the impedance of the cell, which is the measure of the cell's electrical resistance and reactance. From the impedance measurements of the cell, properties of the cell may be determined. The control unit may be configured to determine these properties based on the impedance measurements. These include the cell size, shape and membrane properties. The device may be configured to apply a small electrical current to the cell or the cell-containing fluid, and the resulting voltage changes measured by the electrode assembly can be used to determine the cell's impedance, and thereby the cell type.

In some examples, the device comprises a detection chip comprising a cell fluid channel configured to conduct a flow of a cell-containing fluid, wherein the cell fluid channel is configured to apply a constricting force to a target cell type such that the target cell is deformed in shape as it flows through a measurement region of the cell fluid channel, the measurement region of the cell fluid channel being a portion of the channel illuminated by the light source. The constricting force is preferably applied, or at least has a component, in a direction perpendicular to the flow direction.

wherein a minimum dimension of the cell fluid channel is less than the diameter of a target cell type when flowing unconstricted within the fluid, such that the target cell type is deformed from its unconstricted shape as it flows through the cell fluid channel. Although forces are applied to the cell when flowing in a fluid, this shape of the cell when flowing in the fluid, without the application of a constricting force, is also referred to herein as its “relaxed shape”.

The deformation of the cell in the cell fluid channel causes slowing down of the cells which results in a longer interruption of the elongated light source by the cell, resulting in the cell types being more readily distinguished due to a larger difference in the detected signals between different cell types at the detector. This longer interruption time and deformation in general can be useful for a number of experiments. Furthermore, similar sized cells, with different internal structure, deform in different ways, allowing different cells of a similar size to be distinguished, for example using forward scatter measurements, that in known device fail to distinguish similar size cells.

Examples in which the minimum dimension of the cell fluid channel is less than the diameter of a target cell type when flowing unconstricted within the fluid (referred herein as when the cell is in a “relaxed state”, despite there being some forced applied by the flowing fluid) are advantageous when measuring the impedance of cells. Changes in the shape or dimensions of a cell may affect its interaction with an electric field, thereby also affecting the cells impedance. Obtaining measurements of the cells impedance when the cell is in a relaxed or deformed state allows for determinations to be made about the cell properties such as size so as to determine a cell type.

In some example the detection chip comprises the detection chip comprises a plurality of cell fluid channels, each configured to conduct a flow of a cell-containing fluid, wherein the plurality of cell fluid channels each having a different minimum dimension configured to constrict a different target cell type. A plurality of cell fluid channels means that a plurality of measurements may be acquired at once, speeding up the data acquisition process. This arrangement also allows for the connection to upstream cell sorting chips to direct different cell types into respective cell fluid channel with appropriate dimensions to provide deformation of the respective cell type.

In some examples, the cell detection chip may be configured to provide sheath flow within the cell fluid channel to focus the cell-containing fluid into a region of the cell fluid channel, wherein the sheath flow is configured to provide the constricting force to deform a target cell type as is flows through the measurement region of the cell fluid channel. In particular, a suitable pressure can be applied with a sheath flow to provide the constricting force to deform a target cell type. This can have advantages over the use of specifically dimensioned channels to perform the squeezing since such channels must be manufactured to high precision to achieve the specific dimensions required. In contrast, sheath flow can be used in a larger channel, which are easier and more cost-effective to produce, with the squeezing of cells controlled by the specific parameters of the sheath flow.

The control unit may be configured to control parameters of the sheath flow such that the constricting force applied to a target cell type in the cell containing fluid may be varied by varying the parameters of the sheath flow. In particular, the detection chip may be configured to provide a sheath fluid flow that surrounds the cell-containing fluid, wherein the parameters controlled by the control unit comprises one or more of: the flow rate of the sheath fluid, the flow rate of the cell-containing fluid, the viscosity of the sheath fluid, the hydrophobicity of the sheath fluid. These parameters impact the constricting force applied to a target cell within the cell-containing fluid, thereby allowing the force, and the associated deformation of the cell to be controlled. In some examples, the parameters may be adjusted in response to image data received with the photodetector. In particular, the deformation of the cell can be monitored using data received by the photodetector, and the parameters adjusted in response to precisely adjust the constricting force to applied a required degree of deformation to enhance the signal. In this way, the constricting force can be adapted to different target cell types, without requiring a plurality of precisely machined channels, matched to the target cells.

In some examples, a detection chip comprises a cell fluid channel configured to conduct a flow of a cell-containing fluid, wherein the detection chip may be configured to provide sheath flow to focus the cell-containing fluid through area region of the cell fluid channel. This allows the cells to be directed over a specific region of the photodetector, without requiring a microfluidic channel precisely arranged in a specific position. Again, it opens up the possibility of using larger, more cost effective channels and instead using the control of the sheath flow to direct and control the cell-containing fluid as required. For example, sheath flow may be used to direct the cells consecutively over a specific region of the photodetector, to measure a specific signal from individual cells in turn. In some examples, the cell fluid channel may comprise: a planar cell fluid channel, the planar cell fluid channel extending in a plane parallel with the detection area, wherein the detection chip is configured to provide sheath flow focusing within the plane of the planar cell fluid channel; wherein the height of the cell fluid channel is less than the diameter of a target cell type when flowing unconstricted within the fluid, such that the target cell type is deformed in shape as it flows through the cell fluid channel, the height of the cell fluid channel being a direction normal to the detection area of the detector.

In some examples, the devices may comprise a cell-sorting module, the cell sorting module comprising: an inlet for receiving a cell-containing fluid comprising a plurality of cell types; a cell separator configured to receive the cell-containing sample and separate a target cell type from the plurality of cell types so as to output a cell-containing fluid comprising the target cell type; wherein the cell sorting module is configured to provide the fluid comprising the target cell type to the cell fluid channel of the detection chip when the detection chip is received in the detection module so as to determine the presence of the target cell type flowing through the cell fluid channel with the detection module.

Advantageously, the cell type intended to be detected using the detector are filtered out from any other cells in the fluid sample and provided to the cell fluid channel. As such, the measurements taken of the cells in the cell fluid channel are reliable measures of only the intended cell type, and not other cells. Further, noise in the signals received from the detector that may be caused by other cell types is reduced or fully removed from the signal.

Preferably, the cell separator may comprise one or more of: a lysing module configured to apply a lysing solution to the cell-containing fluid; an inertial microfluidics module configured to separate cell types using inertial microfluidics; a magnetic separation module configured to separate cells bonded to a magnetic label.

A lysing solution is typically a solution used to break down cells. As such, the cells may be broken down into their constituent parts in the cell separator, such that measurements may then be obtained for these constituent parts by the device. Inertial microfluidics can be used for the separation of cells in a fluid based on physical properties such as their size and/or shape. Inertial microfluidics relies on fluid inertia to manipulate the migration of cells. The inertial microfluidics module may include a straight, a spiral, a sinusoidal and/or an expansion-contraction channel. Advantageously, this allows the target cell type to be separated from other cells in the fluid by means of a passive and continuous separation process, so as to not cause damage to the cell. Additionally, it does not require additional energy to be provided to the system to carry out the separation process.

In some examples, the cell sorting module may be integrated on the detection chip and the cell separator is in fluidic communication with the cell fluid channel so that the fluid containing the target cell type flows through the detection module; wherein the detection chip is configured to be releasably received within the detection module to position the cell fluid channel between the light source and photodetector.

In this way, the device has a cell-sorting module combined with the detector chip (i.e. the cell fluid channels of the detector chip are on the same chip as the cell-sorting separator), thereby resulting in a simplified device with reduced components. Being releasably received allows the detection chip to be interchanged with another chip, or to be removed for cleaning or inspection.

In some examples, the device comprises a cell-sorting chip, wherein the cell sorting module is provided on the cell sorting chip; the cell-sorting chip comprising: an outlet arranged to receive the fluid containing the target cell type from the cell separator, the outlet comprising a releasable connection mechanism for connecting to an inlet on the detection chip to conduct the fluid containing the target cell type to a cell fluid channel of the detection chip.

Advantageously, the releasable connection mechanism allows various types of detectors to be connected to various cell sorting chips provided that the output of the cell sorting chip can connect to the inlet of the detection chip. This makes the device flexible and adaptable to different experiments given that both of said chips may be changed to best suit the desired experiment.

In some examples, the device may comprise a plurality of cell-sorting chips, each cell-sorting chip comprising: a cell separator configured to receive a cell-containing sample comprising a plurality of cell types and separate a target cell type from the plurality of cell types so as to output a cell-containing fluid comprising the target cell type, wherein each cell-sorting chip is configured to separate a different target cell type; an outlet arranged to receive the fluid containing the target cell type from the cell separator, the outlet comprising a releasable connection mechanism for connecting to an inlet on the detection chip or another cell-sorting chip.

Advantageously, more than one cell type may be separated from the cell-containing fluid since there are a plurality of cell-sorting chip configured to sort each cell type. This means the device can be used for experiments on more than one target cell type and is not limited to one test or experiment.

In some examples, the plurality of cell sorting chips may be configured such that they may be connected together in different sequences, with each sequence of cell sorting chips providing a different cell-sorting process such that cell-containing fluid output of the outlet of a final cell-sorting chip in the sequence comprises different cell types depending on the sequence in which the cell sorting chips are connected. In this way, the cell-containing fluid can undergo a number of cell sorting steps such that a number of cell types may be removed from the fluid.

In some examples, the one or more cell-sorting chips, each comprise: an inlet on a top surface and an outlet on the bottom surface, the outlet comprising a releasable connection mechanism for connecting to an inlet on the detection chip or another cell-sorting chip; wherein the detection chip and one or more cell-sorting chips connect together in a stacked arrangement. Advantageously, the device has a simple and compact arrangement.

Preferably, the detection chip and one or more cell-sorting chips each comprise a planar body with a broad area top and bottom surface relative to the height, wherein the cell-sorting chips are configured to stack with the broad area top and bottom surfaces adjacent.

In some examples, the device further comprises: a connection layer configured to be positioned between the bottom surface of a first cell-sorting chip and the opposing top surface of a second cell-sorting chip or the detection chip, wherein the connection layer is configured to provide a sealed connection between the outlet of a first cell-sorting chip and the inlet of the second cell-sorting chip or the detection chip.

Advantageously, this reduces the risk of leaks from the said connections by providing a seal. The connection layer may further comprise a patterned pressure sensitive adhesive, PSA. In this way, the connections between said inlets and outlets is strong when using PSA, meaning there are leak-free connections between the layers. This makes the device reliable.

In some examples, the device comprises a differential cell sorting chip, the differential cell sorting chip comprising: an inlet for receiving a blood cell-containing fluid comprising a plurality of white blood cell types; a cell separator for separating blood cell containing fluid into three output channels, one for each of Monocytes, Granulocytes and Lymphocytes, where the cell separator comprises a spiral cell fluid channel; wherein each output channel comprises an outlet for connection to a respective cell fluid channel of the detection chip to count the numbers of Monocytes, Granulocytes and Lymphocytes.

In this way, differential cell sorting is used to separate cell types from a heterogenous population, in this example the population being white blood cells. This device is typically used when providing a differential blood cell count. Advantageously, the differential cell sorting chip separates and isolates the specific cell types of white blood cells, as outlined above, such that further analysis can be carried out on each type independently.

In some examples, the devices comprises a circulating tumour cell, CTC, cartridge, the CTC cartridge comprising: an inlet for receiving a blood cell-containing fluid comprising circulating tumour cells; a cell separator for separating circulating tumour cells into an output channel, where the cell separator comprises a spiral microfluidic channel; wherein the output channel comprises an outlet for connection to a cell fluid channel of the detection chip to count the numbers of circulating tumour cells.

A circulating tumour cell is a cancer cell that has detached from a tumour and has entered the blood stream or lymphatic system. Such cells may be found in samples of blood or other bodily fluids. By separating and counting the numbers of circulating tumour cells in a sample, information on the progression of cancer in the patient to which the sample was obtained can be gained. The control unit may be further configured to determine this information from the count. For example, the progression or treatment of the cancer may be determined from the count.

In some examples, the device may comprise a marking cartridge, the marking cartridge comprising: an inlet for receiving a cell-containing fluid comprising a target cell type; a mixing area for receiving the cell-containing fluid and mixing with biocompatible markers so as to bind the markers to the target cells; an outlet configured to receive the fluid comprising the target cells bound to markers, the outlet configured for connection to a cell fluid channel of the detection chip. The marker is preferably a fluorescent particle. The markers may be any one or more of a fluorescent marker/reporter such as fluorophore-aptamer or antibody conjugates, a enzyme marker, a radioactive markers or anything suitable for marking a biological molecule.

In some examples, the device may comprise a quantum dot, QD, marking cartridge, the QD-marking cartridge comprising: an inlet for receiving a cell-containing fluid comprising a target cell type; a QD mixing area for receiving the cell-containing fluid and mixing with biocompatible QDs so as to bind the QDs to the target cells; an outlet configured to receive the fluid comprising the target cells bound to QDs, the outlet configured for connection to a cell fluid channel of the detection chip.

Quantum dot marking (i.e. quantum dot labelling and quantum dot tagging) is used to label biological molecules such as cells. A quantum dot is a semiconductor crystal with distinctive conductive properties determined by its size. When excited by light, quantum dots emit light of a specific wavelengths dependent on their size or surface themistry, due to quantum confinement. For marking, the QDs bind to the target cell and can be visualised by the emission of light. By comprising a QD-marking cartridge, the cell types can bind with the QDs prior to passing through the cell fluid channel, such that the cells in the channel have been marked and can therefore be easily detected and/or tracked in the channel.

Preferably, QD mixing area may comprises: QDs bonded to a biomolecule, the biomolecule suitable for ligating to a target cell type, such that when the cell-containing fluid comprising the target cell type is introduced into the QD mixing area, target cells become bonded to the QD.

In some examples, the biomolecule may comprise one or more of an aptamer, an antibody, a fluorophore and a nano particles.

In some examples, the device may comprise: an inlet for receiving a cell-containing fluid comprising circulating tumour cells; a QD mixing area for receiving the cell-containing fluid and mixing with antibody-ligated Quantum Dots, QDs, so as to bind the QDs to antigens expressed by the CTCs; an outlet configured to receive the fluid comprising the bound QDs, the outlet configured for connection to a cell fluid channel of the detection chip.

In another aspect of the disclosure there is provided a cell counting device for counting target cells within a fluid, the device comprising: a cell fluid channel configured to conduct a flow of a cell-containing fluid; a light source arranged to illuminate a measurement region of the cell fluid channel, so as to illuminate cells flowing through the measurement region of the cell fluid channel; a photodetector arranged to receive a signal from the illuminated cells to determine the presence of a target cell within the cell-containing fluid; wherein the cell fluid channel is configured to constrict a target cell type such that the target cell type is deformed as it flows through the measurement region of the cell fluid channel.

More specifically, the cell fluid channel is configured such that it provides a constricting force to a target cell type as it flows through the measurement region. Preferably the constricting force is applied, at least partially, in a direction perpendicular to the flow direction. By providing a constricting force within the measurement region, the cell is forced to change shape. This provides greater variation in a range of different optical signals so as to better differentiate different cell types. In particular, the change in shape of a cell under a constricting force depends on its internal structure. Therefore, this change of shape will impart variations in signal in a range of different optical signals, allowing a wider range of cell types to be distinguished using a reduced number of optical signals relative to the prior art. This allows the cell counting device to determine a greater range of target cell types with reduced complexity and lower cost equipment.

Preferably the photodetector is arranged to receive a forward scatter signal from the illuminated cells. Although the use of cell squeezing to provide improved forward scatter signals is disclosed above in combination with a multi pixel photo detector and elongate light source, together providing ease of alignment. It will be appreciated that the improved forward scatter signal achieved from cell squeezing could equally be applied with other types of light source and/or photodetector. In fact the improved differentiation of cell types achieved by deforming a cell when recording a forward scatter measurement could be achieved with any suitable light source and photodetector, for example a point light source, such as a point laser light source. Forward scatter is conventionally described as only allow distinguishing cells based on size, due to the signal primarily relating to diffraction around the cell (with side scatter signal using more complex equipment needed for structural information). However, since cells deform differently depending on their internal structure, combining forward scatter with “cell squeezing” allows for structural information to be obtained purely from forward scatter signal.

A forward scatter signal is particularly advantageous to use with the constriction of target cell types since it shows significant variation depending on the changing cell shape imparted by the constricting force. However, the above features relating to approaches to deforming cells in the measurement region may equally be applied with other signals. For example, the photodetector may alternatively or additionally be configured to receive one or more of the following signals: an absorption signal, a photoluminescence signal, a side scatter signal. In other examples the photodetector may be replaced or supplemented with a detector for measuring an electrical signal imparted by a target cell, such as impedance. Each of the above signals will vary depending on the extent that the cell is deformed by the applied constricting force and therefore the use of “cell squeezing” allows for cell types to be more precisely identified and distinguished. Preferably a minimum dimension of the cell fluid channel is less than the diameter of a target cell type when non-constricted within the fluid (i.e. a freely flowing target cell type), such that the target cell type is deformed from its non-constricted shape as it flows through the measurement region. In this way the constricting force may be applied by the internal walls of the cell fluid channel. In particular, the cell fluid channel may have a dimension perpendicular to the flow direction that is less than the diameter of the target cell type (when flowing unconstricted).

Preferably the cell counting device comprises a plurality of cell fluid channels, each configured to conduct a flow of a cell-containing fluid, wherein the plurality of cell fluid channels each having a different minimum dimension configured to constrict a different target cell type.

Preferably the cell fluid channel is configured to provide sheath flow to focus the cell-containing fluid into a region of the cell fluid channel. Preferably the cell counting device is configured to provide a sheath fluid flow through the cell fluid channel, where the sheath fluid flow surrounds the cell containing fluid within the cell fluid channel.

Preferably the sheath flow is configured such that the sheath fluid provides the constricting force to a target cell type as it flows through the measurement region. Preferably the constricting force is applied, at least partially, in a direction perpendicular to the flow direction. In particular, the cell counting device is configured such that the sheath flow provides a pressure on the target cells within the cell containing fluid.

In some examples, the cell fluid channel may comprise: a planar cell fluid channel, the planar cell fluid channel extending in a plane parallel with the detection area, wherein the detection chip is configured to provide sheath flow focusing within the plane of the planar cell fluid channel.

Preferably the sheath fluid has a different flow rate to the flow of the cell-containing fluid surrounded by the sheath flow. The sheath fluid may have a flow rate of greater than two times the flow rate of the cell-containing fluid, for example three times the flow rate.

Preferably the sheath fluid has different properties to the cell-containing fluid. The sheath fluid may have a different viscosity and/or hydrophobicity to the cell-containing fluid. The viscosity and/or hydrophobicity of the sheath fluid may be selected to provide a required constricting force on the target cell type in the cell containing fluid.

In some examples the sheath fluid may be glycerol. Glycerol is well suited to providing the required squeezing pressure to deform the target cells. In other examples the sheath fluid may comprise an oil. The hydrophobic properties of oils ensure that the cell containing fluid, which is generally water based, will be contained within the sheath flow.

Preferably the cell counting device is configured to provide a variable constricting force to target cells within the measurement region of the cell fluid channel. Preferably the cell counting device is configured to vary the constricting force by varying the properties of the sheath flow. In particular the cell counting device may comprise a control unit configured to control the properties of the sheath flow. The control unit may be configured to increase the pressure applied by the sheath flow to target cells in the cell containing fluid. In particular, the control unit may be configured to vary the flow rate of the sheath fluid to vary the constricting force applied to target cells in the cell containing fluid. The control unit may alternatively or additionally be configured to vary the continents of the sheath fluid, for example by varying the proportion of one or more constituent fluids within the sheath fluid, thereby varying the viscosity and/or hydrophobicity. In this way, the constricting force can be varied depending on a selected target cell type to be constricted in the measurement region of the cell fluid channel.

Preferably the cell counting device comprises a control unit configured to receive the signal from the photodetector and determine the presence of a target cell type flowing through the cell fluid channel based on the signal.

Preferably the cell counting device comprises: a detection chip comprising the cell fluid channel configured to conduct a flow of a cell-containing fluid; a detection module comprising the light source and a photodetector, wherein the detection module is configured to receive the detection chip such that the cell fluid channel is held between the light source and photodetector.

In some examples the light source is configured to provide an elongate illumination area arranged transverse to the cell fluid channel.

In some examples the photodetector comprises a detection area comprising a plurality of detector pixels, arranged such the cell fluid channel runs over the detection area.

In some examples the cell counting device comprises a control unit configured to determine a selection of the detector pixels for collecting the forward scatter signal, receive the forward scatter signal from the selection of photodetector pixels and determine the presence of a target cell type flowing through the cell fluid channel based on the signal.

It will be appreciated that the features disclosed in relation to the first aspect of the invention could each be combined individually or in combination with this aspect of the disclosure.

In another aspect of the disclosure there is provided a cell counting device for counting target cells within a fluid, the device comprising: a cell fluid channel configured to conduct a flow of a cell-containing fluid; a light source arranged to illuminate a measurement region of the cell fluid channel, so as to illuminate cells flowing through the measurement region of the cell fluid channel; a photodetector arranged to receive a signal from the illuminated cells to determine the presence of a target cell within the cell-containing fluid; the cell counting device further comprising a fluorescent particle mixing area positioned upstream of the measurement region of the cell fluid channel, the fluorescent particle mixing area for receiving the cell-containing fluid and mixing with biocompatible fluorescent particles so as to bind the fluorescent particles to the target cells; wherein the light source is configured for exciting a fluorescence signal from the fluorescent particles bound to target cells and the photodetector is configured to receive the fluorescence signal to determine the presence of the target cell type based on the received fluorescence signal.

Preferably the fluorescent particles comprise one or more of biocompatible quantum dots, bio-linkers, fluorescent reporter, fluorophore-aptamer and antibody conjugates.

Preferably the fluorescent particle comprises a quantum dot (QD), wherein the QD mixing area comprises: QDs bound to a biomolecule, the biomolecule suitable for ligating to a target cell type, such that when the cell-containing fluid comprising the target cell type is introduced into the QD mixing area, target cells become bound to the QD via the biomolecule. Preferably the biomolecule comprises one or more of: an aptamer, an antibody, a fluorophore, a nano particle, an antigen, a protein.

Preferably the cell-containing fluid comprises a blood cell containing fluid comprising circulating tumour cells, CTCs, and the cell counting device is configured to count the numbers of circulating tumour cells. Preferably the cell-counting device comprises a QD mixing area for receiving the cell-containing fluid and mixing with antibody-ligated Quantum Dots, QDs, so as to bind the QDs to antigens expressed by the CTCs.

This aspect may additionally comprise any of the features described above in relation to the earlier defined aspects of the invention.

Although the above aspects have been described in relation to cell counting, i.e. determining the presence of a target cell type in a cell containing fluid, they may equally be applied to counting particles more generally. In particular, although cell counting, and more specifically blood-cell counting, is a particularly advantageous application of the disclosed technologies, all aspects of the disclosure could equally be reformulated as a particle counting device for counting target particles within a fluid. For example, the device could be configured for exosomes or artificial cells.

### BRIEF DESCRIPTION OF DRAWINGS

FIG. 1A schematically illustrates a front view of a cell counting device according to an embodiment of the present invention;

FIG. 1B schematically illustrates an exploded view of a cell counting device according to an embodiment of the present invention;

FIG. 2A schematically illustrates an exemplary detection chip comprising a cell fluid channel according to an embodiment of the present invention;

FIG. 2B schematically illustrates an exemplary detection chip comprising a cell fluid channel according to an embodiment of the present invention;

FIG. 2C schematically illustrates an exemplary detection chip comprising a cell fluid channel according to an embodiment of the present invention;

FIG. 3A schematically illustrates the scattering of light from an exemplary target cell type;

FIG. 3B schematically illustrates the scattering of light from an exemplary target cell type when in a cell fluid channel of an exemplary detection chip according to an embodiment of the present invention;

FIG. 3C schematically illustrates the scattering of light from an exemplary target cell type when in a cell fluid channel of an exemplary detection chip according to an embodiment of the present invention;

FIG. 4A schematically illustrates an exemplary detection chip comprising a plurality of cell fluid channel according to an embodiment of the present invention;

FIG. 4B schematically illustrates an exemplary detection chip comprising a plurality of cell fluid channel according to an embodiment of the present invention;

FIG. 4C schematically illustrates an exemplary detection chip comprising a plurality of cell fluid channel according to an embodiment of the present invention;

FIG. 4D schematically illustrates an exemplary detection chip comprising a plurality of cell fluid channel according to an embodiment of the present invention;

FIG. 4E schematically illustrates an exemplary detection chip comprising a plurality of cell fluid channel according to an embodiment of the present invention;

FIG. 4F schematically illustrates using sheath flow to provide a cell fluid channel of an exemplary detection chip according to an embodiment of the present invention;

FIG. 4G schematically illustrates using sheath flow to deform a cell in a cell fluid channel of an exemplary detection chip according to an embodiment of the present invention;

FIG. 4H schematically illustrates an exemplary detection chip comprising a plurality of cell fluid channel according to an embodiment of the present invention;

FIG. 5 schematically illustrates an exploded view of a cell counting device according to an embodiment of the present invention;

FIG. 6 schematically illustrates a cell counting device comprising a detection chip and a cell sorting module according to an embodiment of the present invention;

FIG. 7A schematically illustrates a cell counting device comprising a cell sorting module according to an embodiment of the present invention;

FIG. 7B schematically illustrates a cell counting device comprising a cell sorting module according to an embodiment of the present invention;

FIG. 8A schematically illustrates a cell counting device with a stacked arrangement according to an embodiment of the present invention;

FIG. 8B schematically illustrates a cell counting device with a stacked arrangement according to an embodiment of the present invention;

FIG. 9 schematically illustrates an exploded view of a cell counting device with a stacked arrangement according to an embodiment of the present invention;

FIG. 10 schematically illustrates cell counting device according to an embodiment of the present invention.

### DETAILED DESCRIPTION

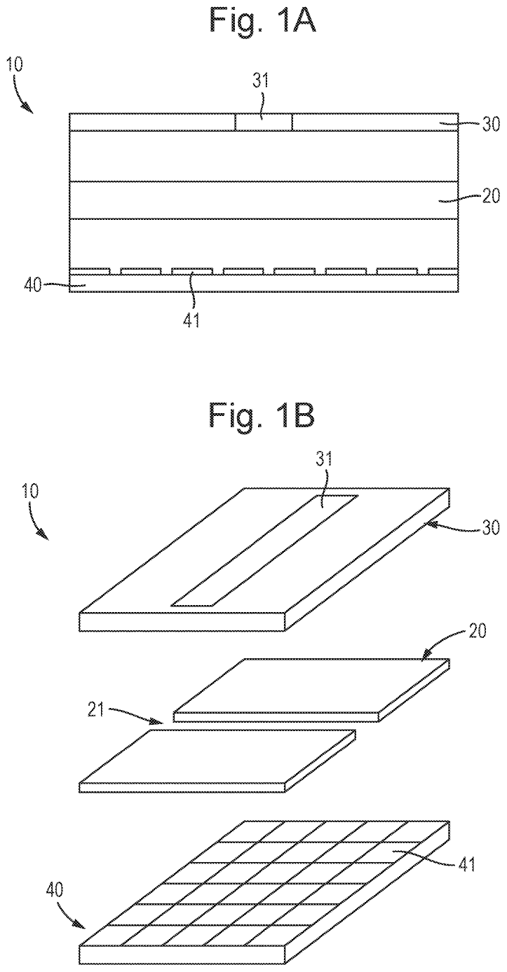

FIG. 1A schematically illustrates a front view of a cell counting device 1 for counting target cells 50 within a fluid F according to the present invention. Device 1 comprises a detection module 10 comprising a light source 31 and a photodetector 40. The detection module 10 is configured to receive a detection chip 20 comprising a cell fluid channel 21 configured to conduct a flow of a cell-containing fluid. As shown in FIG. 1A and FIG. 1B, the detection module 10 is configured to receive the detection chip 20 such that it is held between the light source 31 and photodetector 40. The light source 31 can be located on a light source plate 30 so as to hold it in place. The longitudinal axis of the light source plate 30 may be parallel to a longitudinal axis of the detection chip 20, which may also be parallel to a longitudinal axis of the photodetector 40 as shown in FIG. 1A.

The cell fluid channel 21 is configured to conduct the cell containing fluid F from an inlet to an outlet and comprises a measurement region corresponding to a region of the cell fluid channel 21 that is illuminated by the light source 31. The cell fluid channel may be a microfluidic channel 21. In particular, the channel 21 may have one or more dimensions in the order of micrometers, e.g. 1 to 1000 micrometers, allowing a small amount of fluid to be directed into specific required locations, such as the measurement region for illumination. However, in some examples, as described below, the cell fluid channel 21 may have dimensions greater than 1000 micrometers.

The light source 31 comprises an elongate light source 31 arranged transverse to the cell fluid channel 21, as shown in FIG. 1B. In other words, the elongated light source 31 may be at a 90-degree angle to the cell fluid channel 21. When the detection chip 20 is received in the detection module 10, the elongated light source 31 illuminate cells flowing through the cell fluid channel 21. The elongated light source 31 may have a length of any fraction of the width of the light source plate 30, for example the light source 31 may have a length that is half the width of the light source plate 30, it may have a width that is ⅔ the width of the light source plate 30 etc. provided the length is such the cells 50 of the cell fluid channel 21 can be illuminated. The elongated light source 31 in this example is a line light source 31 (i.e. a continuous illuminated strip), however, in other examples the elongated light source 31 is a plurality of point light sources (i.e. a point-like source of light) arranged along a parallel line or substantially parallel line so as to provide an elongated light source 31. The light source 31 may continuously emit light.

The photodetector 40 comprises a detection area comprising a plurality of detector pixels 41, arranged such the cell fluid channel 21 runs over the detection area when the detection chip 20 is received in the detection module. The photodetector 40 convert light into electrical signals. In some examples, the photodetector 40 comprises an image processing detector such as a complementary metal-oxide-semiconductor (CMOS), a single-photon avalanche diode (SPAD), or a Multi-Pixel-Photon Counter (MPPC). The plurality of detector pixels 41 may also be referred to as an array of pixels (or pixel array). In this example, the pixel array is two-dimensional.

The cell counting device 1 further comprising a control unit configured to determine a selection of the detector pixels 41 for collecting a signal, receive a signal from the selection of photodetector pixels 41 and determine the presence of a target cell 50 type flowing through the cell fluid channel 21 based on the signal.

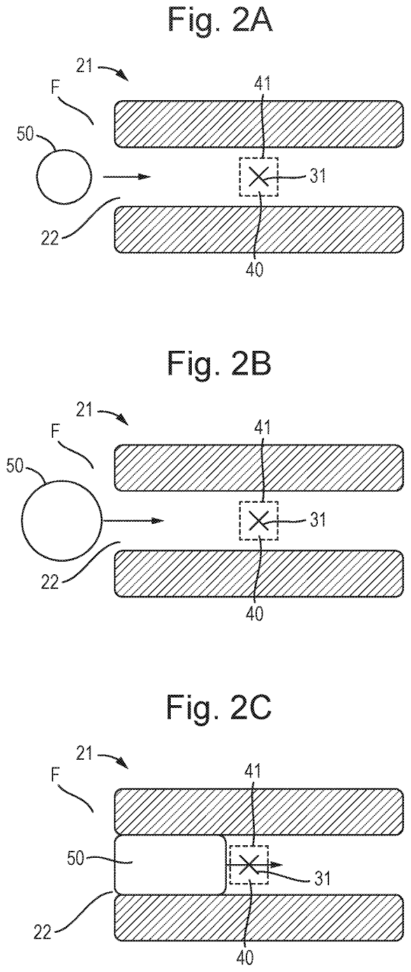

Turning first to the detection chip 20. In some examples, the detection chip 20 comprises a cell fluid channel 21 configured to conduct a flow of a cell-containing fluid F, as shown in FIG. 2A. Specifically, the detection chip 20 comprises cell fluid channel 21 configured to receive a flow of a cell-containing fluid F through an inlet 22 and conduct the flow of the cell-containing fluid along the channel 21 to an outlet. The dimensions of the cell fluid channel 21 are such that the target cells 50 within the fluid F flow consecutively through the cell fluid channel 21. In FIG. 2A, the minimum width dimension and/or depth of the cell fluid channel 21 is greater than the diameter of the target cells 50 but still provides a sufficient channel width restriction such that target cells 50 within the cell-containing fluid F must flow consecutively through the cell fluid channel 21.

In other examples, the minimum width dimension of the cell fluid channel 21 is less than the diameter of the target cell type within the fluid F when in a relaxed state. As demonstrated in FIGS. 2B and 2C, the target cell 50 is forced to deform from its relaxed shape as it flows through the cell fluid channel 21.

The target cell 40 is not limited to the circular shape shown in FIGS. 2A, 2B and 2C. As apparent to the skilled person, the target cells 40 may be any particles or molecules within a solution or fluid F. Preferably, the target cell 40 is a biological particle, molecule or cell of the body found in a bodily fluid. In some examples, the cell-containing fluid F may be prepared prior to its passage through the cell fluid channel 21. The process of preparing the cell-containing fluid will be discussed later in the specification.

In FIGS. 2A, 2B and 2C the elongated light source 31 is perpendicular to the cell fluid channel 21 such that light travels in a direction into the page, as indicated by the “X” in the Figures. In this example, a detector pixel 41 of the photodetector 40 is selected by the control unit such that a signal is collected from light passing through the cell fluid channel 21. If the light from the elongated light source were to travel through the channel 21 at a different location, a different detector pixel 41 would be selected so as to collect light at that location.

One issue with current methods of using cell fluid channels 21 is the high precision required when aligning the channels 21 with other components of the device. As such, it is advantageous for the control unit to be further configured to determine the location of the cell fluid channel 21 when the detection chip 20 is received in the detection module 10 and to determine the selection of detector pixels 41 for collecting a signal based on the determined location of the cell fluid channel 21. In this way, no mechanical intervention of the device is required.

Therefore, in some examples, the control unit is further configured to receive an image from the photodetector 40 and to determine the location of the cell fluid channel 21 using image processing. Examples of image processing include image enhancement, image segmentation, object recognition and texture analysis. The image processing may be carried out using machine learning algorithms.

This detection chip 20 arrangement may be used to obtain measurements for a number of experiments. For example, the detection chip 20 can be configured to determine the cell type by obtaining measurements of the relative intensity of the signal during an interruption time T for a given cell type. The interruption time T is the time in which the signal received at the selected pixel(s) 41 of the photodetector 40 from the light source 31 is reduced due to the target cell type passing over the selected detector pixel(s) 41 of the photodetector 40, thereby blocking or reducing the intensity of the light and reducing the signal for a given period of time as it crosses. As cell 50 passes across the channel 21 and block lights from the elongated light source 31, there will be a change in intensity of the received signal due to varying absorption properties of the cell 50. In one specific example, red blood cells have a central pallor which causes a change in absorption properties and therefore will result in a change in signal intensity at the selected pixels 41. Therefore, the control unit can be configured to use this distinctive change in signal intensity to determine the cell type. The control unit can be further configured to use the interruption time T to distinguish the size and therefore the cell types.

In examples when the minimum width dimension of the cell fluid channel 21 is less than the diameter of the target cell type within the fluid F when in a relaxed state, the flow of the target cell type will slow due to frictional forces, arising from constant contact of the cell with the channel walls, which acts on the target cell type as it moves through the cell fluid channel 21. The slowing down of the cells in the cell fluid channel 21 is advantages for a number of experiments, including those which require time measurements (such as the interruption time T) to be taken for the cell 50. In an instance when the minimum width dimension is less than the diameter of the target cell 40, the cell elongates as it passes through the cell fluid channel 21 creating a longer interruption time T and thereby a more readily identifiable signal at the selected detector pixels 41.

Optionally, the control unit may be configured to adjust the interruption time T measurements to account for cells that have passed through the cell fluid channel 21 previously such that the passing cell can be determined to be the correct cell type. This is advantageous when a cell may slow down or be stuck in the cell fluid channel causing subsequent cells to also slow or stop.

The detector chip 20 may comprise a second elongated light source 31 separate from the first elongated light source 31 and also arranged transverse to the cell fluid channel 21. Therefore, the control unit can be further configured to select detector pixel(s) 41 at a second location, separated from the first location of selected pixels along the cell fluid channel 21 in the flow direction. Since the control unit receives signals from the first selected detector pixels 41 at a first location and signals from the second selected detector pixels 41 at a second location, a speed of the target cell type can be determined, for example, by dividing the known length of the channel 21 by the time between signals from each of the first and second selected detector pixels 41.

In some examples, the light source 31 is a Light Emitting Diode (LED) light source 31 is arranged to provide elongate illumination across the cell fluid channel 21 and the control unit is configured to determine a selection of detector pixels 41 for collecting an absorption or fluorescence photoluminescence signal from cells flowing through the cell fluid channel illuminated by the LED light source 31.

Absorption is when a material absorbs light of a specific wavelength or range of wavelengths. The wavelengths of light absorbed by the cell 50 will not be detected by the detector pixels 41, in other words, these wavelengths will be absent from the received signal at the detector pixels 41. Since different cell types absorb different wavelengths or ranges of wavelengths, the absorption signal can aid in determining the cell type. The control unit may be configured to determine the cell type based on the absorption signal.

Fluorescence occurs when a cell absorbs light of a specific wavelength or range of wavelengths and re-emits light of a given wavelength. Autofluorescence is the natural emission of fluorescence from the target cell produced when the target cell is excited by the excitation light source. In a specific example, the autofluorescence signal can be used to differentiate different cell types that fluoresce at different intensities for a given wavelength. Particularly, in the case where two or more cell types may be the same size such that they cannot be identified from the interruption time T or the speed measurements alone, the cell types may emit a different intensity signal at a given wavelength such that the control unit is able to distinguish between them based on the received fluorescence signal.

As such, it is preferably that the LED light source 31 is configured to excite fluorescence from a target cell type or excite photoluminescence from a marker attached to a target cell type. Further, the detection module 40 can comprise a bandpass filter for permitting the passage of a fluorescence or photoluminescence signal to a portion of the detection area. The bandpass filter may be arranged between the cell fluid channel 21 and the photodetector 40, and may also be configured to block light in the wavelength range emitted by the excitation light source, so as to reduce noise in the received fluorescence signal.

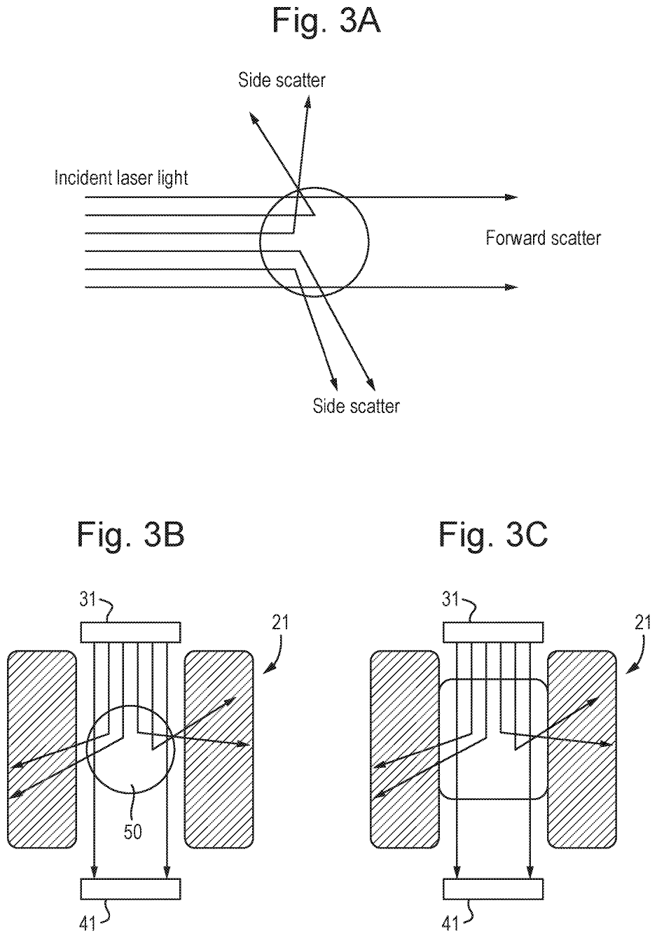

Additionally, or alternative, device 1 may also be used to obtain measurements on the scattering of light by a cell. FIG. 3A shows how light may be scattered by an exemplary cell type. As shown, light is incident on the cell such that the light particles collide with components of the cell type, and are scattered in various directions, including to the side or in the forward direction. Since different cell types have different internal components, light will scatter off cell types differently, such that their size and complexities can be determined using collected signals. Using device 1, measurements of scatter in a specified direction can be obtained by the selection of photodetector pixels. The control unit can be configured to use the scatter information to determine properties of the specific cell type.

In particular, the device 1 can be configured to obtain measurements of forward scatter direction from the cell 50. Forward scatter refers to the scattering of light in the same direction as the incident light. FIG. 3B, shows an example where the flow of cells 50 is consecutive (in a direction out of the page), and the cell 50 is in a relaxed state as it flows through the cell fluid channel 21. A laser light source 31 is arranged to provide elongate illumination across the cell fluid channel 21 and the control unit is configured to determine a selection of detector pixels 41 for collecting a forward scatter signal from cells flowing through the cell fluid channel 21 of the detection chip 20. The selection of pixels 41 may be determined such that they are pixels 41 at a small angle relative to the direction of the laser light beams.

FIG. 3C shows an example where the minimum dimension of the cell fluid channel 21 is less than the diameter of a target cell type within the fluid F when in a relaxed state, such that the target cell type is deformed. Advantageously, accurate information using measurements from forward scatter alone may be obtained without the requirement of detectors positioned to obtained measurements on side scatter.

Optionally, an elongate obstruction mask (not shown) can be arranged over the detection area 40 so as to block direct illumination from the laser light source 31. In this way, the detector pixels 41 only gather light from forward scatter resulting in a reduced background noise and enhanced accuracy of the obtained measurements. The mask may comprise any material or means of at least a portion of the emitted light from the laser. The choice of material may be dependent on the specific wavelength that is desired to be blocked. This can include optical filters, glass or acrylic.

Any applications of the device described above in relation to a detection chip 20 comprising a single cell fluid channel 21 are also applicable to the below-described detection chips 20 comprising a plurality of cell fluid channels 21 and/or detection chips comprising a planar cell fluid channel 21.

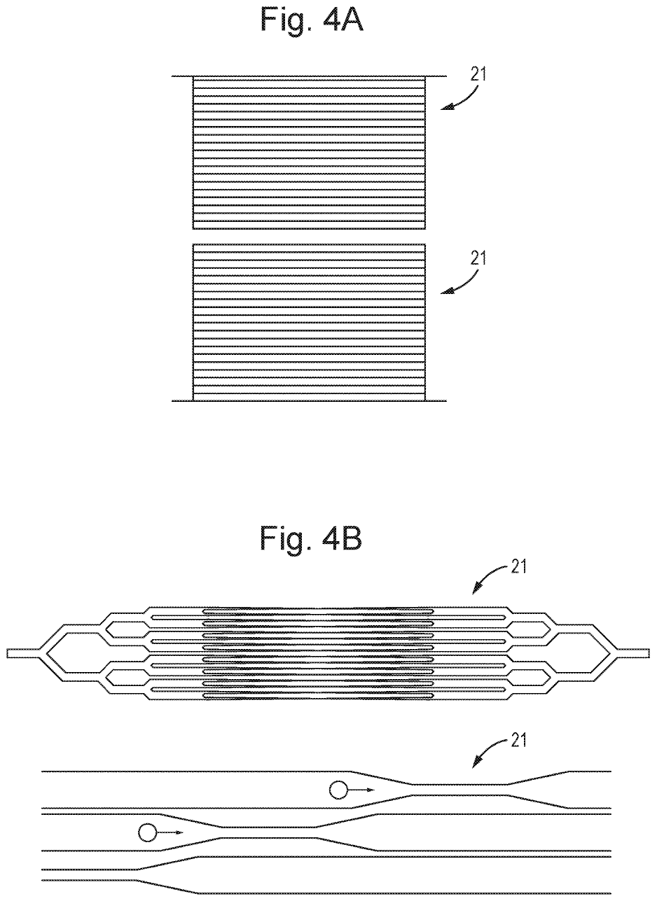

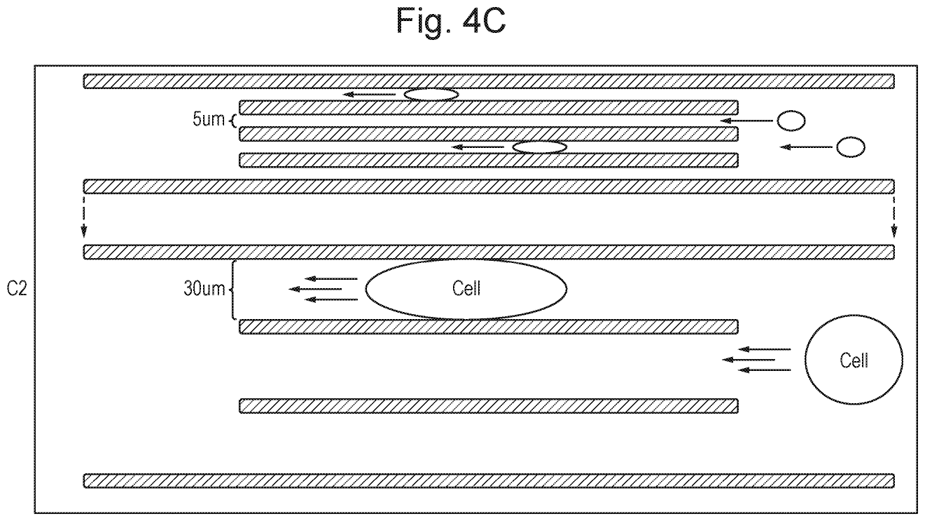

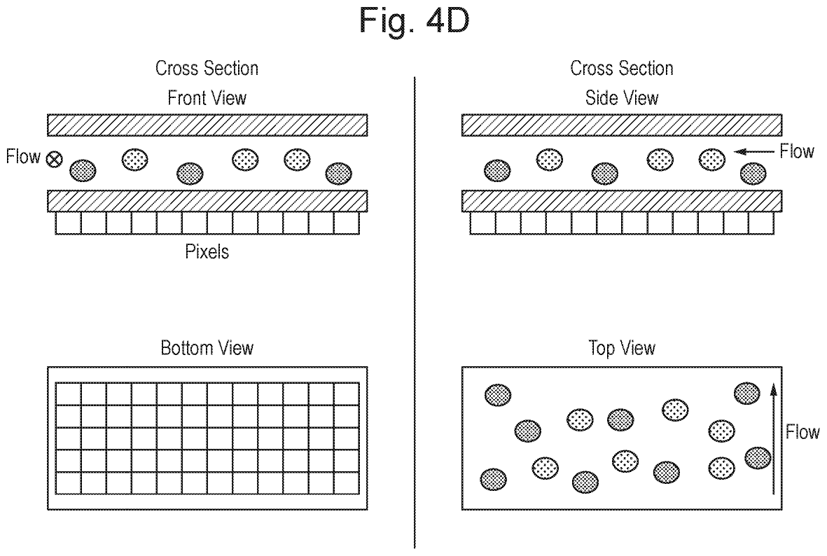

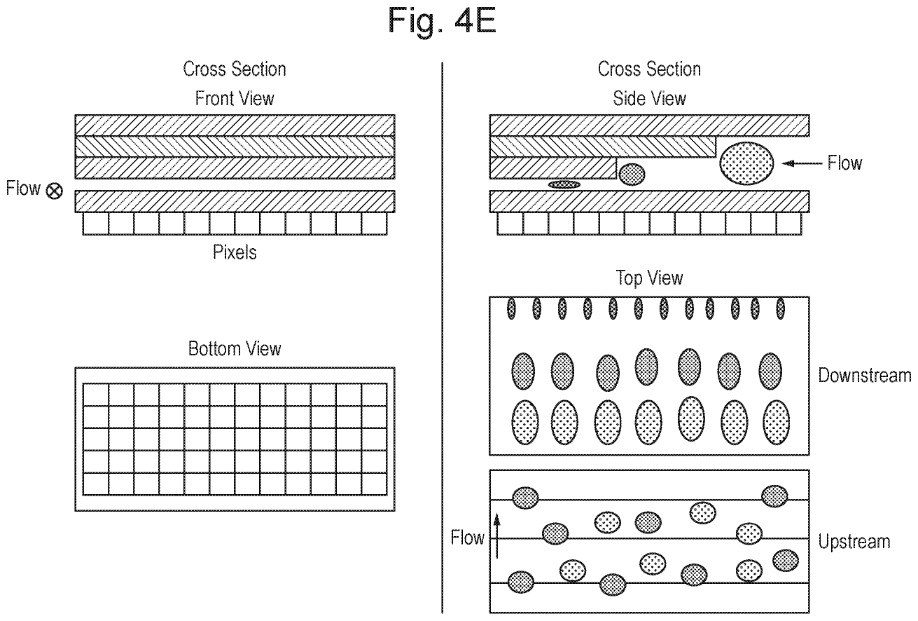

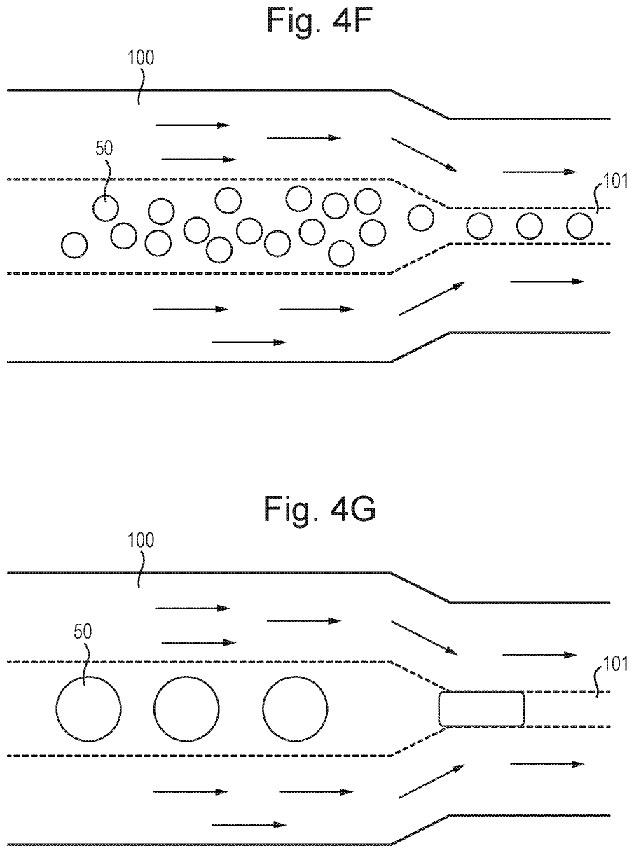

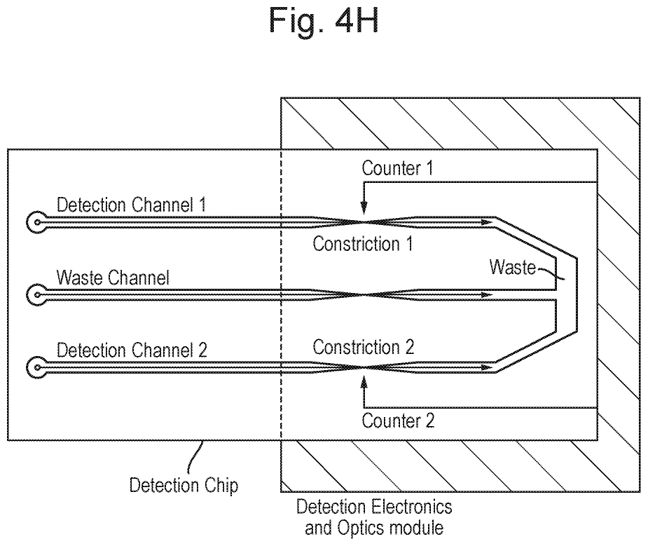

FIGS. 4A and 4B show a detector chip 10 comprises a plurality of cell fluid channels 21 configured to conduct a flow of a cell-containing fluid F. As shown in FIG. 4A, the cell fluid channels 21 may be uniform in shape and size. This detector chip 10 arrangement is advantageous to gathering measurements on many cells of one type simultaneously, making the process of gathering data fast and efficient. Further, the inclusion of a plurality of cell fluid channels 21 improves the reliability of the detection chip 20, as for example, a build-up of cells 50 in one channel 21 will not affect measurements obtained from other channels 21.

The detection chip 20 may include at least one pressure relief channel. FIG. 4B shows the cell counting device 1 comprising a plurality of cell fluid channels 21, each with a pressure relief channel. The pressure relief channels are wider than the cell fluid channel 21 and arranged to permit a portion of the received cell 50 containing fluid F to bypass the cell fluid channel 21, thereby regulating the flow pressure in the cell fluid channel 21.

The plurality of cell fluid channels 21 may have varying dimensions to one another. By configuring the detection chip 20 in this way, a range of measurements for varying cell types can be obtained using a single detection chip 20. In FIG. 4C, the plurality of cell fluid channels 21 are each configured for facilitating deformation of a different target cell type, whereby the different cell types may have a different cell size. As shown, each cell fluid channel 21 has a minimum dimension that is less than the diameter of the respective target cell type when in a relaxed state such that each target cell type is deformed from its relaxed shape as it flows through the respective cell fluid channel 21.

In examples wherein the detection chip 20 comprises a plurality of cell fluid channels 21, each configured to conduct a flow of a cell-containing fluid; the elongate light source 31 is arranged such that it runs across the plurality of cell fluid channels 21 when the detection chip 20 is received in the detection module. In this way, the elongated light source illuminates cells 50 flowing through each cell fluid channel 21. The control unit is configured to determine a respective selection of photodetector pixels 41 for each cell fluid channel 21.

FIG. 4D schematically illustrates an example in which the detection chip 20 comprises a planar cell fluid channel 21. The cell-containing fluid F is conducted through the channel 21 and is configured to conduct flow of multiple cells through the channel 21 adjacent to each other in the width direction perpendicular to the flow direction. In this example, the control unit is configured to receive image data from the photodetector 403 to determine the position of a cell as it flows under the illumination of the light source 31 and determines the selection of detector pixels 41 based on the determined position of the cell. In this way, the light source 31 does not have to align with the channel 21 and detector when fabricating the device.

FIG. 4E schematically illustrates an exemplary detection chip 20 comprising a planar cell fluid channel 21 wherein the height of the cell fluid channel varies in the direction of flow, specifically wherein the height of the channel 21 reduces in the direction of flow. In this way, a number of target cells can flow through the channel 21 of the detection chip 20, whereby larger target cell types will deform by a greater amount causing them to slow down more than smaller target cell types. The cell type can therefore be determined based on an interruption time T as described in detail above. Other embodiments include a planar channel with a gradient height of the cell fluid channel 21, for example, FIG. 4E shows a step reduction in height in the flow direction of the channel 21. In other examples this may be a smooth gradient.

In some examples, the flow of cells 50 may be controlled by a microfluidic channel 21 comprising a physical boundary, while in some examples the flow of the cell-containing fluid may be controlled using sheath flow. In sheath flow, a thin stream of sheath fluid 100 is used to encase a core stream 101 of the sample thereby creating a stable flow of consecutive cells. As shown in FIG. 4F, sheath fluid 100, such as water, phosphate-buffered saline, HBBS or lysing fluid such Ammonium Chloride, Acetic Acid or ACK, is configured to achieve a laminar (proper) flow. Next, cells 50 are introduced into the center of the stream causing the cells 50 to align in a single file, aligned flow. One way of introducing the cells 50 into the sheath flow is by injecting the cells 50 into the channel of sheath fluid 100 at a higher pressure than the sheath fluid 100. The cells 50 may be introduced using a syringe-type mechanism, a pump, or a jet. This reduces the risk of build up or clogging of cells 50 in the device and may improve the accuracy of the measurements obtained. Sheath flow is particularly advantageous for a planar channel 21. For example, sheath flow may be used to create a consecutive flow of cells within the planar channel 21.

In other examples, sheath flow 100 can be used to focus the cell-containing fluid 101 into a region of the cell fluid channel by providing a constricting force to deform the target cell type, as shown in FIG. 4G. By controlling the speed at which the sheath fluid 100 flows, the hydrodynamic forces which cause pressure to act on the cell can be manipulated so as to deform the cell 50. A sheath fluid with a higher viscosity, such as glycerol, may be advantageous, since a greater pressure can be applied to the cell, thereby causing deformation. The sheath fluid may a hydrophobic fluid. The hydrophobic properties and/or the viscosity of the sheath fluid may be used to manipulate the deformation of the target cell type.

FIG. 4H schematically illustrates another exemplary detection chip 20 comprising two cell fluid channels 21 and a waste channel 21. Any of the described detection chips 20 may comprise a waste channel to collect unwanted fluids or cells.

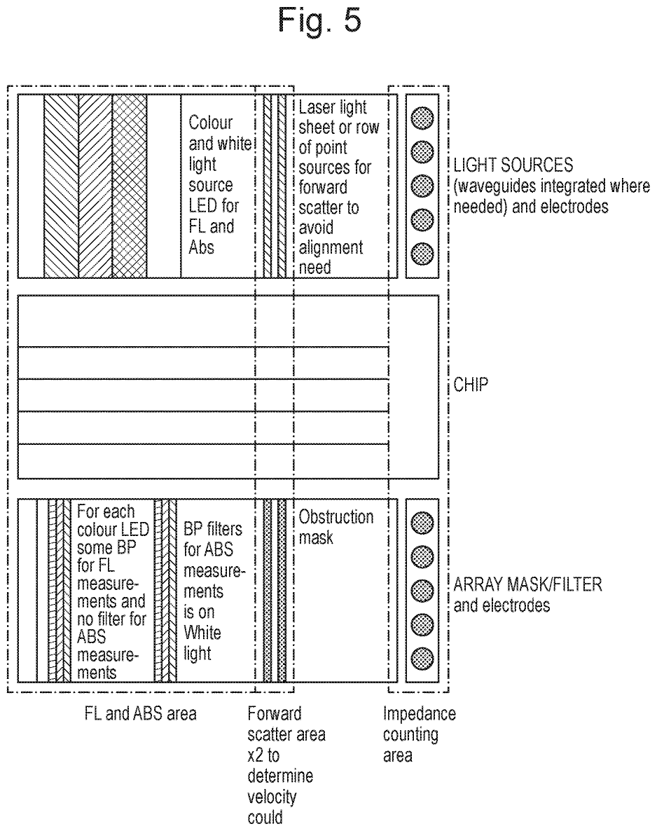

FIG. 5 schematically illustrates an exemplary detection module 10 in which any of the above-mentioned detection chips may be compatible. The detection module 10 comprising four light sources 31, each light source 31 having an elongate light source 31 arranged to provide elongate illumination across the cell fluid channel 21 at a different position along the flow direction of the cell fluid channel 21. In this example, there is one white LED light source 31, and three colour LED light sources 31. The coloured LED light sources 31 are configured to emit light with wavelength(s) in a specified range. One or more of the LED light sources 31 may be configured to emit light of a wavelength that excites fluorescence from the target cell type or a marker attached to the cell type. The specific combination of light sources 31 may vary based on the desired information and measurements required from a given experiment. The control unit is configured to determine a selection of the detector pixels 41 for collecting a signal associated with each of the light sources 31.

In addition to the LED light sources 31, the detection device 1 in FIG. 5 also comprises two elongated laser light sources 31. These may be used to collect forward scatter measurements from the target cell type as described above. As such, the control unit is also configured to determine a selection of detector pixels 41 for collecting a forward scatter signal from cells flowing through the cell fluid channel 21. The detection device 1 further comprises an electrode assembly 32 for measuring an electrical signal imparted by cells 50 flowing through the cell fluid channel 21 of the detection chip when received in the detection module 10. Specifically, the module 10 comprises an electrode assembly 32 for measuring the impedance of cells 50.

The electrode assembly 32 can be made of any suitable conductive materials. Once a stable flow rate is established, by sheath flow or otherwise, an AC electrical signal may be applied to the sample using the electrodes. The frequency of the signal can be varied to measure the impedance over a range of frequencies. Current or voltage measurements across the electrodes can be obtained and analysed to determine the cell impedance. This may be done at the control unit. It should be appreciated that the detection device 1 in FIG. 5 is one exemplary configuration of various light sources 31 and an electrode assembly 32, however, various other arrangements and configurations are possible. Detection module 10 may comprise any of the exemplary detection chips 20 disclosed throughout this specification.

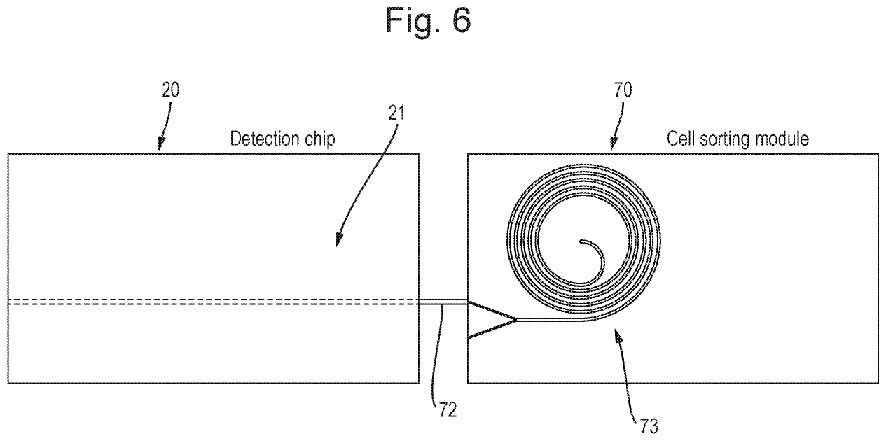

FIG. 6 shows a simplified cell counting device 1 comprising a cell-sorting module 70 and a detection chip 20. The cell sorting module 70 comprises an inlet for receiving a cell-containing fluid F comprising a plurality of cell types. In this specific example, the device 1 comprises a cell-sorting chip, wherein the cell sorting module 70 is provided on the cell sorting chip. The inlet of the cell sorting module 70 is arranged to receive the fluid containing the target cell type and is configured to separate a target cell type from the plurality of cell types so as to output a cell-containing fluid comprising the target cell type. The outlet 72 of the cell sorting module comprises a releasable connection mechanism for connecting to an inlet on the detection chip 20 to conduct the fluid containing the target cell type to a cell fluid channel 21 of the detection chip 20. The releasable connection mechanism can comprise one or more of a quick release mechanism, a flange connection, a push fit connection or any other suitable mechanism that prevents leaking of fluid when the said inlet and outlet are coupled.

In some examples, the cell sorting module 70 is integrated on the detection chip 20. The cell separator is in fluidic communication with the cell fluid channel 21 so that the fluid containing the target cell type flows through the detection module 20 from the cell separator.

As described above, the cell sorting module 70 can be used to separate different types of particles or molecules in the cell-containing sample, or to separate a target cell type(s) from the rest of the population of cells or molecules in the cell-containing sample. There are various mechanisms that may be employed to sort the target cell type(s) from the cell-containing sample. For example, the cell separator may comprise a microfluidic channel 73, wherein the microfluidic channel 73 is different to the cell fluid channels 21 of the detection chip 20. The separation of the target-cell type(s) can be achieved through the application of inertial focusing, wherein an inertial microfluidics module is used as part of the cell separator. Inertial focusing uses hydrodynamic forces generated by laminar flow in microfluidic channel 73 to align and streamline cells. In other words, inertial microfluidics relies on fluid inertia to manipulate the migration of cells in a channel 73. As cells 50 flow through a channel 73 of the microfluidics module, due to an inertial lift force and wall-induced lift force, the cells 50 are forced to align along the centre of the channel 73. By adjusting a flow rate and the shape and/or size of the channel 73, cells of different sizes and shapes can be selectively focused and separated into different outlets. As such, the inertial microfluidics module may include a straight, a spiral, a sinusoidal and/or an expansion-contraction microfluidic channel. The choice of channel may be based on the cell type to be separated.

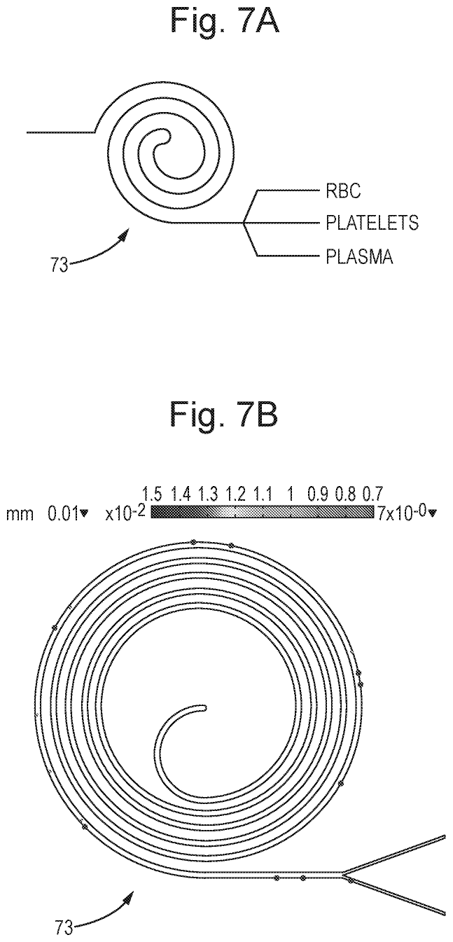

FIG. 7A and FIG. 7B illustrate exemplary inertial microfluidics modules in more detail. In a specific example shown in FIG. 7A, the module comprises a microfluidic channel 73 with a spiral shape of a given diameter and channel geometry for optimal separation of a cell containing fluid F. In a specific example, there are at least three components of a cell-containing fluid: Red Blood Cells (RBC), Platelets and plasma. The spiral of the inertial microfluidics module has both the inlet and three outlets (one for each component), wherein the said inlets are not at the centre of the spiral. Once the cell containing fluid F reaches the outlets, the components of the blood sample have been separated by the inertial microfluidics described above. In this way, each outlet facilitates one of the flow of the RBCs, the flow of platelets or the flow of platelets. FIG. 7B shows another exemplary inertial microfluidics module with a microfluidic channel 73 with an inlet at the centre and two outlets.

In another example, the device 1 comprises a differential cell sorting chip. The differential cell sorting chip comprises an inlet for receiving a blood cell-containing fluid comprising a plurality of white blood cell and the cell separator is configured to separating blood cell containing fluid into three output channels, one for each of Monocytes, Granulocytes and Lymphocytes. In some examples, each output channel comprises an outlet for connection to a respective cell fluid channel 21 of the detection chip to count the numbers at least one of Monocytes, Granulocytes and Lymphocytes.

In another example, the device 1 can be used to separate Circulating Tumour Cells (CTCs) to be separated from other white blood cells using the cell separating module in a similar way to separating white blood cells from each other as described above. This is because CTCs are different in size from other white blood cells. In this example, the cell counting device comprises a CTC cartridge. The CTC cartridge has an inlet for receiving a blood cell-containing fluid comprising circulating tumour cells a cell separator for separating circulating tumour cells into an output channel, where the cell separator comprises a spiral microfluidic channel; and the output channel comprises an outlet for connection to a cell fluid channel of the detection chip to count the numbers of circulating tumour cells.

In some examples, the device 1 comprises a quantum dot (QD) marking cartridge. Quantum dot marking is a process of attaching quantum dots to a target cell type so as to enable the detection and/or visualisation of the target cell. The QD-marking cartridge comprises: an inlet for receiving a cell-containing fluid comprising a target cell type, a QD mixing area for receiving the cell-containing fluid and mixing with biocompatible QDs so as to bind the QDs to the biomolecules. The mixing area may additionally comprise a suitable mixing agent to enable the biomolecules to bond with the QD. The mixing area may additionally or alternative comprise a linker, such as a lipid, antibody or tagged protein, to aid in the bonding process. In this way, the QD mixing area will then comprise QDs bonded to a biomolecule, the biomolecule suitable for ligating to a target cell type, such that when the cell-containing fluid comprising the target cell type is introduced into the QD mixing area, target cells become bonded to the QD. The QD marking cartridge also comprises an outlet configured to receive the fluid comprising the target cells bound to QDs, the outlet configured for connection to a cell fluid channel of the detection chip.

In some examples, the device 1 comprises an inlet for receiving a cell-containing fluid comprising circulating tumour cells; a QD mixing area for receiving the cell-containing fluid and mixing with antibody-ligated Quantum Dots, QDs, so as to bind the QDs to antigens expressed by the CTCs; an outlet configured to receive the fluid comprising the bound QDs, the outlet configured for connection to a cell fluid channel of the detection chip.

In some examples, the cell separator comprises a lysing module configured to apply a lysing solution to the cell-containing fluid F. In some examples, the lysing solution is configured to break down target cell type in order to isolate a particular cellular component. In a specific example, lysing solution is used in blood tests to break open cells. In this specific example haematological stain (crystal violet or aqueous methylene blue) in 1-2% acetic acid and distilled water is used as the lysing solution to destroy the membrane of white blood cells, red blood cells and platelets within a blood sample. Additionally, it may stain the nuclei of the white blood cells.

In some examples, the cell separator comprises a dilution module. The dilution module may be configured to add buffer solution, solvent or any suitable sample to the cell-containing fluid so as to reduce the concentration of target cell types in a sample.

In some examples, the device 1 can comprise a plurality of any of the above-mentioned cell-sorting chips. Each cell-sorting chip comprises a cell separator configured to receive a cell-containing sample comprising a plurality of cell types and separate a target cell type from the plurality of cell types so as to output a cell-containing fluid comprising the target cell type, wherein each cell-sorting chip is configured to separate a different target cell type, and an outlet arranged to receive the fluid containing the target cell type from the cell separator, the outlet comprising a releasable connection mechanism for connecting to an inlet on the detection chip or another cell-sorting chip.

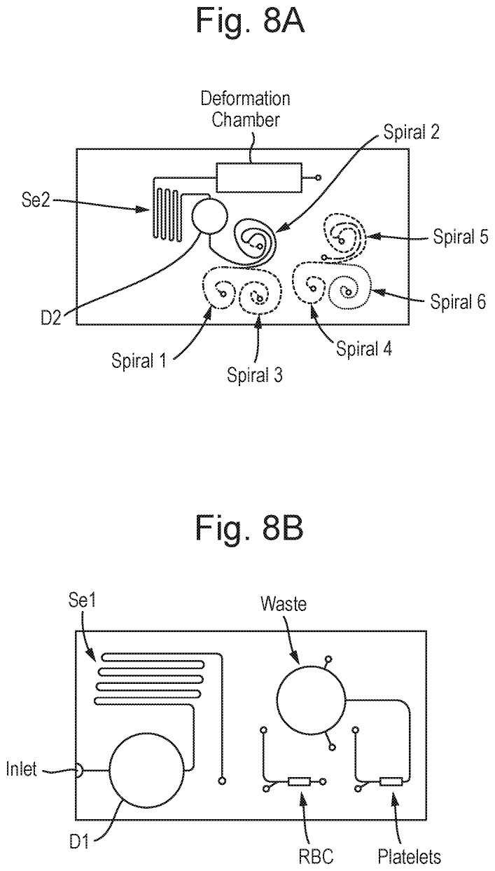

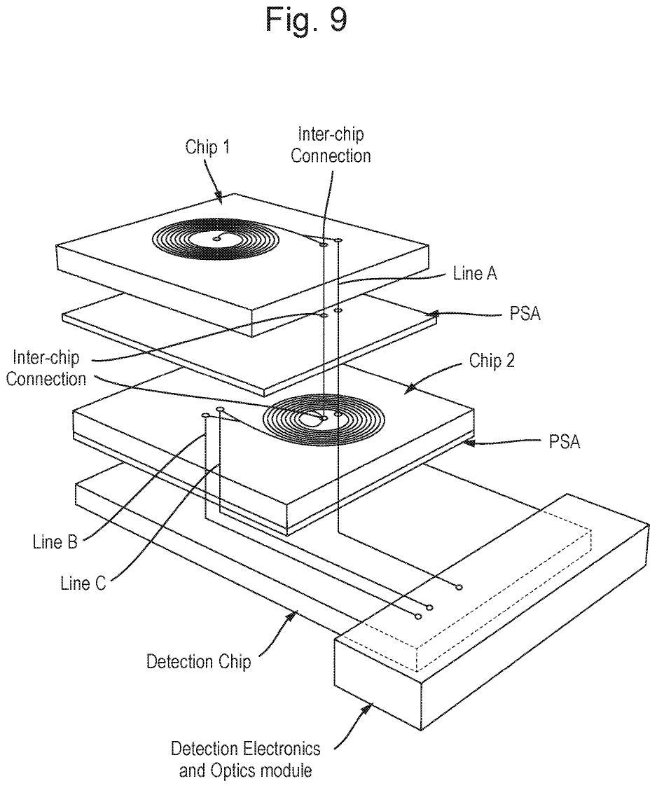

FIG. 8A and FIG. 8B show a device 1 comprising a plurality of cell sorting chips. In this example, the inlets and outlet of the spiral microfluidic channels 73 are connected over two layers such that the detection chip 20 and one or more cell-sorting chips connect together in a stacked arrangement. In this way, the cell sorting chips each comprise an inlet on a top surface and an outlet on the bottom surface, the outlet comprising a releasable connection mechanism for connecting to an inlet on the detection chip or another cell-sorting chip. FIG. 9 illustrates the stacked arrangement in more detail.

FIG. 9 schematically illustrates a device 1 comprising a detection chip 20 and two cell-sorting chips each comprise a planar body with a broad area top and bottom surface relative to the height, wherein the said cell-sorting chips are configured to stack with the broad area top and bottom surfaces adjacent.

In FIG. 9, cell sorting chip 1 comprises a first spiral microfluidic channel 73 with an inlet at the centre and two outlets. These outlets then connect to the inlet of a second spiral microfluidic channel 73 on cell sorting chip 2 via a vertical channel resulting from an alignment of holes in each layer of the stack. In this way, the spiral microfluidic channels 73 are connected over two layers. As shown, the pressure sensitive adhesive (PSA) is positioned between cell sorting chip 1 and cell sorting chip 2. This may also be referred to as a connection layer that is configured to be positioned between the bottom surface of a first cell-sorting chip and the opposing top surface of a second cell-sorting chip or the detection chip. The connection layer is configured to provide a sealed connection between the outlet of a first cell-sorting chip 1 and the inlet of the second cell-sorting chip 2 and/or the detection chip 20. In this way, the PSA layer provides a strong and leak free connection between the layers. The said layers can be assembled by applying moderate pressure on the stack of chips, thereby giving precise alignment. Advantageously, this may be done in a factory or at home.

As shown, the outlets of the second microfluidic channel 73 releasably connect to an inlet on the detection chip 20, and there is another PSA layer between the cell sorting chip 2 and the detection chip. In other examples, the cell sorting chip 2 may be integrated into the detection chip 20.

In a specific example using the cell sorting device in FIG. 9, device 1 is used for separating a specific target cell type from a whole blood sample. Line A in FIG. 9 represents the “useful” outlet in which the separated target cell type pass to the detection chip 20 through the vertical channel as shown. The target cell types may then be counted using any one of the above-described optical or impedance methods as facilitated by the detection chip 20. The first cell sorting chip 1 may comprise a “waste” outlet which is configured to facilitate flow of the remainder of the separated sample, as shown by the Line C in FIG. 9. This waste outlet may be connected to an inlet on the second cell sorting chip 2, also via a vertical channel, such that the remaining sample can undergo further separation on the second cell sorting chip 2. In other examples, the outlet of the waste channel on the first sell sorting chip 1 may be connected directly to a waste channel on the detection chip 20.

It should be appreciated that the number of cell-sorting chips included in a device may vary and the arrangement of each said chip is not limited to those shown in FIG. 9. The cell-sorting chips of the device are interchanged, so as to allow different cell types to be separated for various tests or experiments.

In this specific example, a number of the plurality of cell sorting chips are configured such that they are connected together in different sequences. Each of the sequences provides a different cell-sorting process such that cell-containing fluid output of the outlet of a final cell-sorting chip in the sequence comprises different cell types depending on the sequence in which the cell sorting chips are connected.

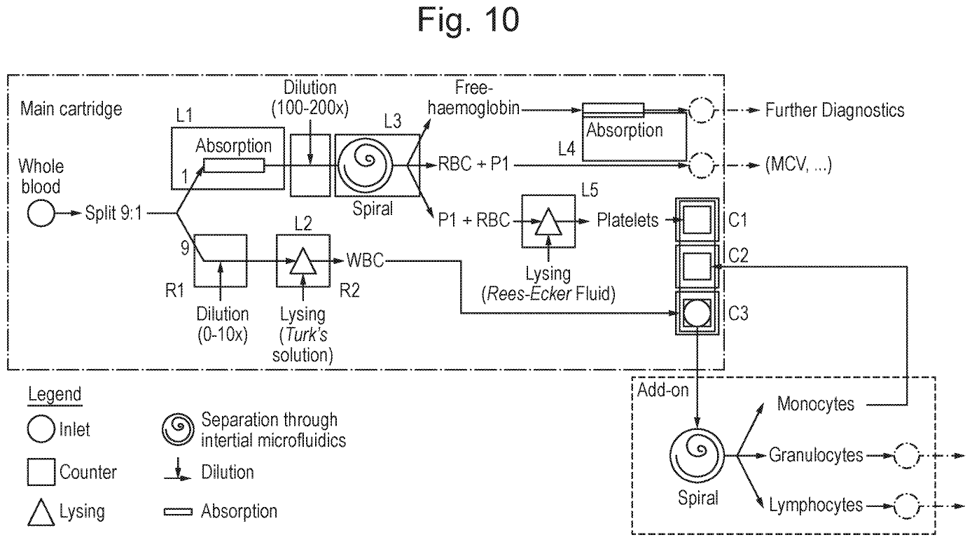

FIG. 10 schematically illustrates an exemplary cell-counting device comprising a number of the above-described components configured to carry out a full blood count. At S91 a whole blood sample is being pushed with active flow through an inlet of a channel that bifurcates i.e. the single channel splits into two channels. The sample may be pushed with active flow using a force or mechanism, for example, pumps, pressure gradient, electric fields or chemical reactions can be used. The two channels can have different widths, and for example the left channel 1 may receive 10% of the sample while the right channel may receive the remaining 90% of the sample. Any one of the above-described cell sorting chips may be employed to carry out this split. the sample in this way is advantageous as the ratio of WBC to RBC is approximately 1:1000 in a blood sample, and so the difficulty when carrying out a full blood cell count arises from a difficulty in counting the WBCs, due to their low ratio. Therefore, removing RBC from a sample is required to avoid unwanted noise signals in the WBC signal.

At L1 a detection chip comprising at least one cell fluid channel is configured to conduct a flow of the cell-containing fluid from the channel 1. The cell fluid channels of these examples are “microfluidic channels”, i.e. have dimensions in the micrometer range. In some examples, as described above, the channels may have dimensions beyond this range. For example, in the case of planar channels, where cells may flow over a wider area. Therefore, in some examples the channels conducting the flow are not always “true” microfluidic channels. Nevertheless, given the standard use of this term in the art, in the following example, and generally herein, the channels through which the cell containing fluid is conducted may be referred to as “microfluidic channels”. Specifically, the control unit is configured to determine a selection of detector pixels for collecting an absorption from cells flowing through the cell fluid channel in order to measure haemoglobin level in the channel as a proxy count for RBCs. In this example, the absorption wavelength is 495 nm of RBCs, therefore the LED light source is configured to emit light at this wavelength or a range of wavelengths including 495 nm. In some examples, the absorption measurements are done under flow in a chamber that has a greater depth to increase the sensitivity of the measurement.

At L2 is a dilution module. An outlet from the above-described cell fluid channel merges with a dilution channel which is configured to introduce a dilution fluid so as to dilute the RBC concentration by for example 100-200 times.

At L3 the outlet of the dilution module connects to an inlet of a cell fluid channel 21 with a spiral shape of a given diameter and channel geometry for optimal separation of three components of a cell-containing fluid: Red Blood Cells (RBC), Platelets and plasma. Firstly, the resultant sample from the dilution module maybe mixed by following the spiral (serpentine) path configured for optimal mixing of the solution. In some examples, the spiral is identical to that shown in FIG. 7A. As such, the spiral comprises three outlets, one for each of the components, wherein one outlet facilitates the flow of the RBC, another facilitates flow of free haemoglobin, and another facilitates flow of Platelets. In practice, the RBC outlet mainly comprises RBCs but may comprise a small proportion of platelets due to the overlap in size of these cells, and the platelet outlet may comprise mainly platelets and a small proportion of RBCs. The plasma outlet contains no cells.

At L4 is a detection chip like that described at L1 but contains no cells. It is used to measure free haemoglobin in blood as a marker for haemolysis and serves as control absorption to be subtracted from the measurements of L1 for more accurate estimate of RBC count.

At L5 is a lysing module in which the outlet containing platelets from the spiral at L3 is connected to an inlet of the lysing module. A lysing solution (e.g. Rees-Ecker Fluid) is applied to the fluid so as to stain the platelets and lyse RBC.

At C1 the platelets in the sample are counted. At C1 is a detection chip comprising one or more microfluidic channels that are configured to conduct the flow of the platelet containing fluid. In one example, the channels have a width and depth of 5 um. Any of the above-described detection chips may be used to conduct the flow of the platelet containing fluid such that the control unit can collect a signal from the selected detector pixels and determines a count for the platelets in the sample. In one example, the platelets may be detected from a signal at the detector pixels caused by the forward scatter of the platelets.

At R1 is a dilution module. The cell containing fluid is diluted by 10-20× so as to not disperse the WBCs too much increases the time for the counting of all the WBC in the sample, however, some dilution is required to optimize for flow and to have enough volume to go through the entire detection counter modules. At R2 is a lysing module, where a lysing solution (e.g. Turk) is applied to the cell containing fluid, such that the RBCs and platelets in the cell containing fluid are lysed, leaving only the WBCs.

The cell containing fluid then flows from an outlet of the lysing module to a cell separating module. In this example, the cell separating module is similar to that described previously in which the cell separator comprises a spiral microfluidic channel with three output channels, one for each of Monocytes, Granulocytes and Lymphocytes. In this example, the microfluidic channel can be 30 um in width and depth. Each output channel comprises an outlet for connection to a respective microfluidic channel of the detection chip to count the numbers of Monocytes, Granulocytes and Lymphocytes. The counting of the cells may be done using signals at the detector pixels from forward scattered light is used to count the cells.

1. A cell counting device for counting target cells within a fluid, the cell counting device comprising:
a detection module comprising a light source and a photodetector, the detection module configured to receive a detection chip comprising a cell fluid channel configured to conduct a flow of a cell-containing fluid, the detection module configured to receive the detection chip such that it is held between the light source and photodetector;
wherein the light source is configured to illuminate cells flowing through the cell fluid channel when the detection chip is received in the detection module;
wherein the photodetector comprises a detection area comprising a plurality of detector pixels, arranged such that the cell fluid channel runs over the detection area when the detection chip is received in the detection module; the cell counting device further comprising:
a control unit configured to determine a selection of the detector pixels for collecting a signal, receive a signal from the selection of the detector pixels and determine a presence of a target cell type flowing through the cell fluid channel based on the signal.

2. The cell counting device according to claim 1, wherein the light source comprises an elongate light source arranged transverse to the cell fluid channel when the detection chip is received in the detection module so as to illuminate cells flowing through the cell fluid channel.

3. The cell counting device according to claim 2 wherein:
the detection module is configured to receive a detection chip comprising a plurality of cell fluid channels, each configured to conduct a flow of a cell-containing fluid;
the elongate light source is arranged such that it runs across the plurality of cell fluid channels when the detection chip is received in the detection module, so as to illuminate cells flowing through each cell fluid channel; and
the control unit is configured to determine a respective selection of photodetector pixels for each cell fluid channel.

4. The cell counting device according to claim 1, wherein the control unit is further configured to:
determine a location of the cell fluid channel when the detection chip is received in the detection module; and
determine the selection of detector pixels for collecting a signal based on the determined location of the cell fluid channel.

5. (canceled)

6. The cell counting device according to claim 1, wherein:
the detection module is configured to receive a detection chip comprising a planar cell fluid channel, the planar cell fluid channel extending across the detection area in a width direction, perpendicular to a direction of flow, so as to allow multiple cells to flow through the planar cell fluid channel adjacent to each other in the width direction;
wherein the control unit is configured to receive image data from the photodetector to determine a position of a cell as it flows under the illumination of the light source and determine the selection of detector pixels based on the determined position of the cell.

7. The cell counting device according to claim 1, wherein the light source comprises:
a laser light source arranged to provide elongate illumination across the cell fluid channel; wherein
the control unit is configured to determine a selection of detector pixels for collecting a forward scatter signal from cells flowing through the cell fluid channel.

8. The cell counting device according to claim 7 comprising:
a detection chip comprising a cell fluid channel configured to conduct a flow of a cell-containing fluid, wherein the cell fluid channel is configured to apply a constricting force to a target cell type such that the target cell is deformed in shape as it flows through a measurement region of the cell fluid channel, the measurement region of the cell fluid channel being a portion of the channel illuminated by the laser light source.

9. The cell counting device according to claim 1, wherein the light source comprises:
an LED light source arranged to provide elongate illumination across the cell fluid channel; wherein
the control unit is configured to determine a selection of detector pixels for collecting an absorption or photoluminescence signal from cells flowing through the cell fluid channel illuminated by the LED light source.

10. The cell counting device according to claim 1, wherein:
the detection module comprises a plurality of light sources, each light source comprising an elongate light source arranged to provide elongate illumination across the cell fluid channel at a different position along a flow direction of the cell fluid channel; wherein
the control unit is configured to determine a selection of the detector pixels for collecting a signal associated with each light source of the plurality of light sources.

11. The cell counting device according to claim 10 wherein the detection module comprises:
a laser light source arranged to provide elongate illumination across a first position on the cell fluid channel for providing a forward scatter signal; and
an LED light source arranged to provide elongate illumination across a second position on the cell fluid channel for providing an absorption and/or photoluminescence signal; wherein
the control unit is configured to determine a first selection of detector pixels for collecting a forward scatter signal from cells flowing through the cell fluid channel and a second selection of detector pixels for collecting an absorption and/or photoluminescence signal.

12. The cell counting device according to claim 1, wherein the detection module comprises:
an electrode assembly for measuring an impedance of cells flowing through the cell fluid channel of the detection chip when received in the detection module.

13. The cell counting device according to claim 1, comprising:
a detection chip comprising a cell fluid channel configured to conduct a flow of a cell-containing fluid, wherein the cell fluid channel is configured to apply a constricting force to a target cell type such that the target cell is deformed in shape as it flows through a measurement region of the cell fluid channel, the measurement region of the cell fluid channel being a portion of the channel illuminated by the light source.

14. The cell counting device according to claim 13 wherein a minimum dimension of the cell fluid channel is less than [[the]]a diameter of a target cell type when flowing unconstricted within the fluid, such that the target cell type is deformed from its unconstricted shape as it flows through the measurement region of the cell fluid channel; and
wherein the detection chip is configured to provide sheath flow within the cell fluid channel to focus the cell-containing fluid into a region of the cell fluid channel, wherein the sheath flow is configured to provide the constricting force to deform a target cell type as is flows through the measurement region of the cell fluid channel.

15. (canceled)

16. The cell counting device according to claim 13, wherein a minimum dimension of the cell fluid channel is less than a diameter of a target cell type when flowing unconstricted within the fluid, such that the target cell type is deformed from its unconstricted shape as it flows through a measurement region of the cell fluid channel;
wherein the detection chip is configured to provide sheath flow within the cell fluid channel to focus the cell-containing fluid into a region of the cell fluid channel, wherein the sheath flow is configured to provide a constricting force to deform a target cell type as is flows through the measurement region of the cell fluid channel; and
wherein the control unit is configured to control parameters of the sheath flow such that the constricting force applied to a target cell type in the cell-containing fluid may be varied by varying the parameters of the sheath flow; wherein the parameters controlled by the control unit comprises one or more of: a flow rate of a sheath fluid, a flow rate of the cell-containing fluid, a viscosity of the sheath fluid, or [the]a hydrophobicity of the sheath fluid.

17. The cell counting device according to preceding claim 1, comprising:
a detection chip comprising a cell fluid channel configured to conduct a flow of a cell-containing fluid, wherein the detection chip is configured to provide sheath flow to focus the cell-containing fluid through a region of the cell fluid channel.

18. The cell counting device according to claim 1, further comprising a cell-sorting module, the cell-sorting module comprising:
an inlet for receiving a cell-containing fluid comprising a plurality of cell types;
a cell separator configured to receive a cell-containing sample and separate a target cell type from the plurality of cell types so as to output a cell-containing fluid comprising the target cell type;
wherein the cell-sorting module is configured to provide the fluid comprising the target cell type to the cell fluid channel of the detection chip when the detection chip is received in the detection module so as to determine the presence of the target cell type flowing through the cell fluid channel with the detection module; wherein the cell separator comprises one or more of:
a lysing module configured to apply a lysing solution to the cell-containing fluid;
an inertial microfluidics module configured to separate cell types using inertial microfluidics;
a magnetic separation module configured to separate cells bonded to a magnetic label.

19. The cell counting device of any of claim 18, further comprising:
a cell-sorting chip, wherein the cell-sorting module is provided on the cell cell-sorting chip; the cell-sorting chip comprising:
an outlet arranged to receive the fluid containing the target cell type from the cell separator, the outlet comprising a releasable connection mechanism for connecting to an inlet on the detection chip to conduct the fluid containing the target cell type to a cell fluid channel of the detection chip.

20. The cell counting device of claim 18, comprising a plurality of cell-sorting chips, each cell-sorting chip comprising:
a cell separator configured to receive a cell-containing sample comprising a plurality of cell types and separate a target cell type from the plurality of cell types so as to output a cell-containing fluid comprising the target cell type, wherein each cell-sorting chip is configured to separate a different target cell type;
an outlet arranged to receive the fluid containing the target cell type from the cell separator, the outlet comprising a releasable connection mechanism for connecting to an inlet on the detection chip or another cell-sorting chip;
wherein the plurality of cell-sorting chips are configured such that they may be connected together in different sequences, with each sequence of cell sorting chips providing a different cell-sorting process such that cell-containing fluid output of the outlet of a final cell-sorting chip in the sequence comprises different cell types depending on the sequence in which the cell sorting chips are connected.

21. (canceled)

22. The cell counting device of claim 19, wherein the one or more cell-sorting chips each comprise a planar body with a broad area top and bottom surface relative to the height, each cell sorting chip further comprising:
an inlet on the top surface and an outlet on the bottom surface, the outlet comprising a releasable connection mechanism for connecting to an inlet on the detection chip or another cell-sorting chip; wherein
the detection chip and one or more cell-sorting chips connect together in a stacked arrangement with the broad area top and bottom surfaces adjacent.

23. (canceled)

24. (canceled)

25. The cell counting device of claim 19, comprising a fluorescent particle marking cartridge, the fluorescent particle marking cartridge comprising:
an inlet for receiving a cell-containing fluid comprising a target cell type;
a fluorescent particle mixing area for receiving the cell-containing fluid and mixing with biocompatible fluorescent particles so as to bind the biocompatible fluorescent particles to the target cells;
an outlet configured to receive the fluid comprising the target cells bound to fluorescent particles, the outlet configured for connection to a cell fluid channel of the detection chip; wherein the fluorescent particles comprise one or more of biocompatible quantum dots, bio-linkers, fluorescent reporter, fluorophore-aptamer and antibody conjugates.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)
